(19) United States
(12) Patent Application Publication
(10) Pub. No.: US 2025/0031732 A1
(43) Pub. Date: Jan. 30, 2025

(54) FLAVOURING AGENT, COMPOSITION, PRODUCTION METHOD AND USE OF AROMATISING AND FLAVOURING AGENTS BASED ON VANILLA EXTRACT

(71) Applicants: UNIVERSIDADE FEDERAL DO ESTADO DO RIO DE JANEIRO, Rio de Janeiro (BR); UNIVERSIDADE FEDERAL DO RIO DE JANEIRO, Rio de Janeiro (BR)

(72) Inventors: Andrea MACEDO FURTADO, Rio de Janeiro (BR); Maria GABRIELA BELLO KOBLITZ, Rio de Janeiro (BR); Rafael GARRETT DA COSTA, Rio de Janeiro (BR); Joana PAULA DA SILVA OLIVEIRA, Rio de Janeiro (BR)

(21) Appl. No.: 18/713,953

(22) PCT Filed: Nov. 29, 2022
(86) PCT No.: PCT/BR2022/050468

§ 371 Date: May 28, 2024

(30) Foreign Application Priority Data
Nov. 29, 2021 (BR) 102021024019-9
Nov. 29, 2022 (BR) 1020220243140

(51) Int. Cl. A23L 27/12; A23L 27/10; A23L 27/30; C11B 9/00

(52) U.S. Cl. CPC A23L 27/12; A23L 27/11; A23L 27/30; C11B 9/00

(57) ABSTRACT

The present invention relates to the production of perfuming, aromatising, taste-enhancing and/or flavouring agents and compositions based on extracts from wild, domesticated and/or modified vanilla fruit from the biodiversity of the Brazilian Atlantic Forest flora, which have a metabolome and proteome that differ from those of the Vanilla planifolia vanilla, generating new vanilla aromas and flavours that can be used in cosmetics, foods, pharmaceuticals and nutraceuticals, perfumes, textiles, wood and plastic articles, repellents and other products that can carry this essence.

### FIELD OF INVENTION

The present invention refers to the production of flavouring agents and/or flavouring/aromatising agents based on vanilla extracts, which have aromas and flavours that differ from those of the vanillas used on the market, as they are based on extracts originating from wild, domesticated and/or modified vanilla fruits originating from the biodiversity of the Brazilian Atlantic Forest (as well as similar or adjacent biomes), which present compounds and/or proportions of compounds not yet found in other vanillas.

The agents of the present invention can be consumed directly or through the production of compositions/products that are intended to incorporate the flavour, aroma or biological properties of these extracts, such as: cosmetic, food, pharmaceutical, nutraceutical products, perfumery, textile, wooden, plastic and other articles that can carry its essence, and even insect repellent compositions, not limited to them alone.

### BACKGROUND OF THE INVENTION

The Vanilla planifolia Andrews species is the main commercial source of vanilla, the most universally used flavouring ingredient and the third most expensive natural spice in the world [Morlock, G. E., Busso, M., Tomeba, S., & Sighicelli, A. (2021). Effect-directed profiling of 32 vanilla products, characterization of multi-potent compounds and quantification of vanillin and ethylvanillin. Journal of Chromatography A, 462377]. In addition to the attractive aroma of their extracts, vanillas may also have antioxidant, antimutagenic, hypolipidemic activity and have potential as a food preservative and anticarcinogen. [Singletary, K. W. (2020). Vanilla: potential health benefits. Nutrition Today, 55(4), 186-196].

The pantropical Vanilla spp., popularly known as vanilla, belongs to the tribe Vanilleae, which is subcosmopolitan in distribution and contains 10 genera, including Vanilla Plum. ex Mill. Many species in this genus are considered rare or endangered, due to the destruction of their original habitat [Ramirez-Mosqueda, M. A., Iglesias-Andreu, L. G., Teixeira da Silva, J. A., Luna-Rodriguez, M., Noa-Carrazana, J. C., Bautista-Aguilar, J. R., . . . Murguia-González, J. (2019). In vitro selection of vanilla plants resistant to Fusarium oxysporum f. sp. vanillae. Acta Physiologiae Plantarum, 41(3), 1-8. https://doi.org/10.1007/s11738-019-2832-y]. Vanilla spp. are monophyletic and are represented by 37 species in Brazil [Pansarin, E. R., Aguiar, J. M., & Ferreira, A. W. (2012). A new species of Vanilla (Orchidaceae:Vanilloideae) from São Paulo, Brazil. Brittonia, 64(2), 157-161. URL: https://link.springer.com/article/10.1007/s12228-011-9215-z; Ferreira, A. W. C., Franken, E. P., & Pansarin, E. R. (2020). Confirmation of the presence of Vanilla hartii Rolfe (Orchidaceae, Vanilloideae) in Brazil. Check List, 16, 951]. This genus is economically important due to V. planifolia Andrews, which is a natural source of vanillin [Patricia Rain (2004) Vanilla: The Cultural History of the World's Favorite Flavour and Fragrance. Published by Tarcher]. The species most used for commercial purposes are the American species (V. planifolia and V. pompona Schiede), although V. pompona is considered a lower quality source, and the Tahitian species (V. tahitensis J. W. Moore). According to Hoehne, V. trigonocarpa is also an excellent producer of vanilla [Ana Kelly Koch, Claudio Nicoletti de Fraga, João Ubiratan M. dos Santos, and Anna Luiza Ilkiu-Borges (2013) Taxonomic Notes on Vanilla (Orchidaceae) in the Brazilian Amazon, and the Description of a New Species Source: Systematic Botany, 38(4):975-981. Published By: The American Society of Plant Taxonomists URL: http://www.bioone.org/doi/full/10.1600/036364413X674706; Andriamihaja, C. F., Ramarosandratana, A. V., Grisoni, M., Jeannoda, V., Besse, P. (2020) The Leafless Vanilla Species-Complex from the South-West Indian Ocean Region: A Taxonomic Puzzle and a Model for Orchid Evolution and Conservation Research. Diversity, 12, 443]. Containing around twenty-five phenolic compounds responsible for the characteristic aroma and flavour, vanilla has become the most universally used flavouring ingredient [Hrazdina, G. (2006). Aroma production by tissue cultures. Journal of Agricultural and Food Chemistry, 54(4), 1116-23. doi:10.1021/jf053146w; Havkin-Frenkel, D., Belanger, F. Handbook of Vanilla Science and Technology, 2nd ed., John Wiley & Sons Ltd, Hoboken, NJ, USA, 2019]. Its application covers confectionery, food products, beverages, ice cream, perfumes and pharmaceutical preparations [Dong, Z., Gu, F., Xu, F., & Wang, Q. (2014). Comparison of four kinds of extraction techniques and kinetics of microwave-assisted extraction of vanillin from Vanilla planifolia Andrews. Food Chemistry, 149, 54-61. doi:10.1016/j.foodchem.2013.10.052; Arya, S. S., Rookes, J. E., Cahill, D. M., & Lenka, S. K. (2021). Vanillin: a review on the therapeutic prospects of a popular flavouring molecule. Advances in Traditional Medicine. https://doi.org/10.1007/s13596-020-00531-w].

In addition to their extracts with an attractive aroma, vanilla-based compositions have several applications in health, such as antioxidant, antimutagenic, hypolipidemic activity, and have considerable potential as a food preservative and anticarcinogen [Andrade, H. H. R., Santos, J. H., Gimmler-Luz, M. C., Correa, M. J. F., Lehmann, M., & Reguly, M. L. (1992). Suppressing effect of vanillin on chromosome aberrations that occur spontaneously or are induced by mitomycin C in the germ cell line of Drosophila melanogaster. Mutation Research, 279, 281-287; Jadhav, D., Rekha, B. N., Gogate, P. R., & Rathod, V. K. (2009). Extraction of vanillin from vanilla pods: A comparison study of conventional Soxhlet and ultrasound assisted extraction. Journal of Food Engineering, 93, 421-426; Al-Naqeb, G., Ismail, M., Bagalkotkar, G., & Adamu, H. A. (2010). Vanillin rich fraction regulates LDLR and HMGCR gene expression in HepG2 cells. Food Research International, 43, 2437-2443]; Bezerra, D. P., Soares, A. K. N., Sousa, D. P. de (2016) Overview of the Role of Vanillin on Redox Status and Cancer Development. Oxid. Med. Cell. Longev., 2016, 9734816; Singletary, K. W. (2020). Vanilla: potential health benefits. Nutrition Today, 55(4), 186-196].

The essence of vanilla is extracted from the elongated fruits of some species of Vanilla. Vanilla is one of the most expensive spices in the world, due to the high cost of obtaining its extracts [Walton, N. J., Mayer, M. J., & Narbad, A. (2003). Vanillin. Phytochemistry, 63(5), 505-515. doi:10.1016/S0031-9422(03)00149-3; Aviles, D. (2018). Unique Aspects of the Vanilla Market. McKeany-Flavell Company, Oakland, CA, USA. https://www.mckeany-flavell.com/wp-content/documents/McKeany-Flavell_MarketOutlook_Vanilla_2018.pdf. Accessed on Apr. 20, 2021; Martău, G. A., Călinoiu, L. F., & Vodnar, D. C. (2021). Bio-vanillin: Towards a sustainable industrial production. Trends in Food Science & Technology].

At the end of the 19th century, the most abundant active ingredient in Vanilla was identified and produced artificially and the natural extraction of the active ingredient was replaced, in many cases, by artificial production. However, as the natural product is the result of a complex combination of several substances, in addition to vanillin, it has a clearly superior quality and, for this reason, these plants continue to be cultivated in some tropical countries [Daugsch, A. (2005). Revisão. Science, 28(4), 642-645; Martău, G. A., Călinoiu, L. F., & Vodnar, D. C. (2021). Bio-vanillin: Towards a sustainable industrial production. Trends in Food Science & Technology]. Most of the marketed production comes from Mexico, the islands of Madagascar and Comore [Hrazdina, 2006; Anuradha, K., Shyamala, B. N., Naidu, M. M. (2013) Vanilla—its science of cultivation, curing, chemistry, and nutraceutical properties. Crit. Rev. Food Sci. Nutr., 53 (12), 1250-1276].

However, Mexico's forests have been destroyed by farmers, thus reducing the source of the natural gene that, when crossed with cultivated Vanilla, could improve production and increase resistance to pests and diseases [Bythrow, J. (2005). Vanilla as a Medicinal Plant. Seminars in Integrative Medicine, 3(4), 129-131; Ramírez-Mosqueda, M. A., Iglesias-Andreu, L. G., Teixeira da Silva, J. A., Luna-Rodriguez, M., Noa-Carrazana, J. C., Bautista-Aguilar, J. R., . . . Murguia-González, J. (2019). In vitro selection of vanilla plants resistant to Fusarium oxysporum f. sp. vanillae. Acta Physiologiae Plantarum, 41(3), 1-8. https://doi.org/10.1007/s11738-019-2832-y; Flanagan, N. S., Chavarriaga, P., & Mosquera-Espinosa, A. T. (Eds.). (2018). Conservation and Sustainable Use of Vanilla Crop Wild Relatives in Colombia. In Handbook of Vanilla Science and Technology (pp. 85-109). https://doi.org/10.1002/9781119377320.ch6].

The fermented fruits of “true” vanilla contain about 2% vanillin, depending on the place of origin (Madagascar 1.76%; Mexico 1.75%; Sri Lanka 1.5%, Indonesia 2.75%) [Morlock, G. E., Busso, M., Tomeba, S., & Sighicelli, A. (2021). Effect-directed profiling of 32 vanilla products, characterization of multi-potent compounds and quantification of vanillin and ethylvanillin. Journal of Chromatography A, 462377; Gassenmeier, K., B. Riesen, and B. Magyar. “Commercial quality and analytical parameters of cured vanilla beans (Vanilla planifolia) from different origins from the 2006-2007 crop.” Flavour and Fragrance Journal 23, no. 3 (2008): 194-201.].

In vanilla capsules of exceptional quality, vanillin crystals may be visible on the surface in the form of small white needles (called, in French, givre) [Rodriguez-Jimenes, G. C., Vargas-Garcia, A., Espinoza-Pérez, D. J., Salgado-Cervantes, M. a., Robles-Olvera, V. J., & Garcia-Alvarado, M. a. (2012). Mass Transfer During Vanilla Pods Solid Liquid Extraction: Effect of Extraction Method. Food and Bioprocess Technology, 6(10), 2640-2650. doi:10.1007/s11947-012-0975-6]. However, vanillin is not exclusively responsible for the flavour of vanilla. The participation of other less abundant volatiles is as important as vanillin [Dong, Z., Gu, F., Xu, F., & Wang, Q. (2014). Comparison of four kinds of extraction techniques and kinetics of microwave-assisted extraction of vanillin from Vanilla planifolia Andrews. Food Chemistry, 149, 54-61. doi:10.1016/j.foodchem.2013.10.052]. In fact, vanillin is present in almost all vanilla fruits, so its presence does not contribute significantly (less than 12%) to the diversity of vanilla flavour found among cured fruits [Khoyratty, S., Kodja, H., & Verpoorte, R. (2018). Vanilla flavour production methods: a review. Industrial Crops and Products, 125, 433-442]. In addition to vanillin (85% of total volatile compounds), other important aromatic components found are p-hydroxybenzaldehyde (above 9%), vanillic acid (4.3%) and p-hydroxybenzyl methyl ether (1%). Other important flavour components include p-hydroxybenzoic acid, p-hydroxybenzaldehyde, vanillic acid (4-hydroxy-3-methylbenzoic acid), p-hydroxybenzyl alcohol, anisic alcohol, and vanillic alcohol. Even traces of the aforementioned compounds modify the flavouring aspects of the plant extracts.

More than 200 compounds have been identified in vanilla extracts (phenols, alcohols, esters, lactones, heterocyclic compounds, among others). Two stereoisomeric vitispirans, although occurring only in trace concentrations, also influence the flavour and aroma of vanilla [Hrazdina, 2006; Morlock, G. E., Busso, M., Tomeba, S., & Sighicelli, A. (2021). Effect-directed profiling of 32 vanilla products, characterization of multi-potent compounds and quantification of vanillin and ethylvanillin. Journal of Chromatography A, 462377; Sinha, A. K., Sharma, U. K., & Sharma, N. (2008). A comprehensive review on vanilla flavour: Extraction, isolation and quantification of vanillin and other constituents. International Journal of Food Sciences and Nutrition, 59(4), 299-326. https://doi.org/10.1080/09687630701539350].

Annual prices for high quality vanilla fruits have shown variations by a factor of about 20 ($30-600 per kg) over the past three decades. Only 1% of vanillin on the global market is extracted from vanilla fruits. Driven by the ongoing trend towards natural ingredients and the diverse applications of vanillin in end-use industries, the market has witnessed an increase in demand for natural vanillin. The global vanillin market size is expected to reach US$725 million by 2025 [Aviles, D. (2018) Unique Aspects of the Vanilla Market. McKeany-Flavell Company, Oakland, CA, USA. https://www.mckeany-flavell.com/wp-content/documents/McKeany-Flavell_MarketOutlook_Vanilla_2018.pdf. Accessed on Apr. 20, 2021; Grand View Research (2017) Vanillin Market Size, Share & Trends Analysis Report By End-use (Food & Beverage, Fragrance, Pharmaceutical), By Region (North America, Europe, Asia Pacific, Central & South America, MEA), And Segment Forecasts, 2018-2025. San Francisco CA, USA. www.grandviewresearch.com/industry-analysis/vanillin-market. Accessed on Apr. 20, 2021].

Due to the time-consuming and laborious process used in its production, natural vanilla is expensive, at US$2,000/lb, while synthetic vanillin, produced from lignin or guaiacol, is relatively cheap, costing around US$6/lb [Zidi, C., Tayeb, R., Boukhili, N., & Dhahbi, M. (2011). A supported liquid membrane system for efficient extraction of vanillin from aqueous solutions. Separation and Purification Technology, 82, 36-42; Martiu, G. A., Calinoiu, L. F., & Vodnar, D. C. (2021). Bio-vanillin: Towards a sustainable industrial production. Trends in Food Science & Technology; Morlock, G. E., Busso, M., Tomeba, S., & Sighicelli, A. (2021). Effect-directed profiling of 32 vanilla products, characterization of multi-potent compounds and quantification of vanillin and ethylvanillin. Journal of Chromatography A, 462377].

Given this scenario, vanilla has become the second most expensive spice in the world, after saffron [García-Bofill, M., Sutton, P. W., Straatman, H., Brummund, J., Schürmann, M., Guillen, M. and Álvaro, G. (2021). Biocatalytic synthesis of vanillin by an immobilised eugenol oxidase: High biocatalyst yield by enzyme recycling. Applied Catalysis A: General, 610, p. 117934. URL: https://doi.org/10.1016/j.apcata.2020.117934].

Although V. planifolia is the only species of the genus with wide industrial applicability, it is severely threatened with extinction in its area of origin, due to environmental destruction and predatory exploitation in situ [Soto Arenas MA. Vainilla: los retos de un cultivo basado en una especie amenazada con una historia de vida compleja. Congreso internacional de productores de vainilla, México, 2006; Ellestad, P., Forest, F., Serpe, M., Novak, S. J., & Buerki, S. (2021). Harnessing large-scale biodiversity data to infer the current distribution of Vanilla planifolia (Orchidaceae). Botanical Journal of the Linnean Society, 196(3), 407-422].

Other species of the genus represent a valuable source for improving V. planifolia in terms of resistance to diseases and improving aromatic quality [Bory S; GRISONI M; DUVAL MF; BESSE P. Biodiversity and preservation of vanilla: present state of knowledge. Genet resour crop evol, 55:551-571, 2008; Flanagan, N. S., & Mosquera-Espinosa, A. T. (2016). An integrated strategy for the conservation and sustainable use of native vanilla species in Colombia. Lankesteriana, 16(2), 201-218. https://doi.org/10.15517/lank.v16i2.26007; Lepers-Andrzejewski, S., Brunschwig, C., Collard, F.-X., & Dron, M. (2010). Morphological, chemical, sensory and genetic specificities of Tahitian vanilla. Vanilla, 205-228].

To this end, there is a global effort to protect and chemically characterize the biodiversity of vanillas, an aspect that has not yet been considered for Brazilian vanillas.

In the Brazilian Atlantic Forest there are three species of Vanilla: V. bahiana (also known as V. phaeantha), V. chamissonis and V. cribbiana [Brumano, C. N. (2019). A trajetória social da baunilha do cerrado na cidade de Goiás/GO. Universidade de Brasilia; Vieira, R. F., Camillo, J., & Coradin, L. (2016). Espécies Nativas da Flora Brasileira de Valor Econômico Atual ou Potencial. In Plantas para o Futuro-Região Centro-Oeste. Brasília], with precarious use by industry. The first occurs more in the regions of Pars, Pernambuco, Bahia, Espirito Santo and Rio de Janeiro, while V. chamissonis is distributed along the Brazilian coast, from Espirito Santo to Rio Grande do Sul, especially in coastal vegetation, but also on the edge of forests in the interior of these states, and V. cribbiana, a species described in 2010, occurs in the State of Pars, the State of Mato Grosso, Bahia and, probably, in many other states, according to Koch et al. (2013) [Hoehne FC. Orchidaceas. São Paulo: secretaria da agricultura, vol. 12, 1953; Soto Arenas, M. A., Cribb, F. 2010. A new infrageneric 8iferente8tion and synopsis of the genus Vanilla Plum. Ex Mill. (Orchidaceae:Vanillinae). Lankesteriana 9:355-398; Koch, A. K., Fraga, C. N., Santos, J. U. M., Ilkiu-Borges, A. L. 2013. Taxonomic notes on Vanilla (Orchidaceae) in the Braziliana Amazon, and the Description of a New Species. Systematic Botany 38: 975-981.].

Vanilla chamissonis Klotzsch originates from Central America and northern South America, distributed in Southeastern Brazil, always in regions of cultivation or abandoned cultivation, as observed by Pabst (1967) [Pabst, G. F. (1967). As Orquidáceas do Território Federal do Amapá. Atas: Botânica, 4, 167; Reis, C. A. M. (2000). Biologia reprodutiva e propagação vegetativa de Vanilla chamissonis Klotzsch: subsidios para manejo sustentado (Doctoral dissertation, Universidade de São Paulo); Lopes, A. B., Silva, M. M., & Junior, J. C. F. M. (2018). Estratégias funcionais de Vanilla chamissonis (Orchidaceae) em ambiente arbustivo e florestal de restinga (Structural and ecophysiological strategies of the hemiepiphyte Vanilla chamissonis Klotzsch (Orchidaceae) in different microhabitats of Restinga). Revista Brasileira de Geografia Fisica, 12(2), 355-364; MACHADO, O. (1946). O FRUTO DA VANILLA CHAMISSONIS KLTZ. Rodriguésia, (20), 49-50; de Oliveira, S. A., de Oliveira Takeda, A., Facioli, A. P., Ferreira, R. G., Vaz, S. R., & de Freitas, T. T. (2007). Propagação por estaquia em Orquidea Vanilla chamissonis Klotzsch. Ornamental Horticulture, 13, 1679-1682; Ribeiro, V. C., Fernandes, J. V., Baleeiro-Santos, R., Caires, C. S., Andre, C., & Leitio, E. CARACTERIZAÇÃO ESTRUTURAL E HISTOQUÍMICA DOS NECTÁRIOS EXTRAFLORAIS BRACTEAIS DE Vanilla chamissonis (ORCHIDACEAE); Reis, C. A. M., Brondani, G. E., & de Almeida, M. Biologia floral, reprodutiva e propagação vegetativa de baunilha. Scientia Agraria Paranaensis, 10(1), 69]. It is usually confused with Vanilla bahiana Hoehne. In turn, this last species has also been confused, in the floristic lists of the Brazilian Southeast and Northeast regions, with Vanilla espiritusantense Ruschi, Vanilla chamissonis var. brevifolia Cogn. and Vanilla planifolia Andr., appearing correctly cited only in Pabst (1975) [Pabst, G. F., & Dungs, F. (1975). Orchidaceae brasilienses (Vol. 1). Brucke-Verlag Schmersow] for the State of Pernambuco, and in Fraga & Pereira (1998) [Fraga, C. N., & Pereira, O. J. (1998). Orchidaceae da comunidade pós-praia das restingas do Estado do Espirito Santo. Caderno de Pesquisa da UFES, 8, 65-72], for the post-beach region of the State of Espirito Santo. Recently, Vanilla bahiana Hoehne and/or V. phaeantha Rchb.f. It was collected at various points along the coast of Espirito Santo, and was also deposited in herbaria in Rio de Janeiro, as observed in Fraga & Pereira (1998), which greatly increases its geographic distribution. From now on, V. phaeantha and/or V. bahiana will be referred to simply as V. bahiana. [Barberena, F. F. V. A., Hermoso, E. L., & de Oliveira, M. A. J. (2021). Distribución espacial de Vanilla bahiana (Orchidaceae) en dos fitofisonomías de restinga. ¿El patrón espacial varía? Collectanea Botanica, 40, e001-e001; Nascimento, T. A. D., Furtado, M. D. S. C., Pereira, W. C., & Barberena, F. F. V. A. (2019). Vanilla bahiana Hoehne (Orchidaceae): studies on fruit development and new perspectives into crop improvement for the Vanilla planifolia group. Biota Neotropica, 19]. Vanilla cribbiana Soto Arenas was described by Soto Arenas and Dressler (2010) for Mexico and Central America and registered, for the first time, for Brazil by Koch et al. (2013), being represented in herbaria by few materials and treated by Silva e Silva (2010, pg. 490) as V. gardneri Rofe, thus probably present in other places in Brazil, such as in the Atlantic Forest of Bahia, where it was collected by Andrea Furtado Macedo, who is part of the group behind the present invention [Silva, M. F. F., Silva, J. B. F. (2020). Orquídeas nativas da Amazônia Brasileira II. Universidade Federal Rural da Amazônia/Museu Emílio Goeldi, Belém; Engles, M. E., Rocha, L. C. F., Koch, A. K. (2020). Novidades em Vanilla Mill. (Orchidaceae) para a borda sul-amazônica, Estado do Mato Grosso, Brasil. Hoena, 47: e032020].

As they are species that have not yet been studied, Atlantic Forest orchids have not been commercially used as flavouring agents and their potential to be a substitute for the source of vanilla extract on the market is not known.

Based on the literature, it is believed that most orchid fruits do not have amounts of vanillin that make them substitutes for V. planifolia, they do not even present a new composition that would change the standards expected for a vanilla essence.

It is possible to recognize a desire in the market to search for V. planifolia substitutes and even find new complex compositions, containing new elements, volatile or not, so that the flavouring agents previously used can be enriched. One option arises in the development of new cultivars to obtain flavours and aromas previously unavailable.

New technologies from the post-genomic era, for example, are used to improve the development of aromatic plants and the production of secondary metabolites, avoiding the use of agricultural inputs and the exploitation of natural resources in situ. However, in some cases, the use of genetic engineering to improve metabolite production can be challenging due to the numerous gaps that remain in the understanding of plant biology. For example, it is not yet known how some secondary metabolites are biosynthesized, or how their synthesis is regulated by complex networks involving genes, transcripts, proteins and metabolites in biological systems [Verpoorte, R. & J. Memelink. (2002). Engineering secondary metabolite production in plants. Curr. Opin. Biotechnol. 13, 181-187; Sarsaiya, S., Shi, J., & Chen, J. (2019). Bioengineering tools for the production of pharmaceuticals: current perspective and future outlook. Bioengineered, 10(1), 469-492].

In this sense, proteomics and metabolomics studies can and are used to guide the development of aromas in plant [Yu, D., Gu, X., Zhang, S., Dong, S., Miao, H., Gebretsadik, K., & Bo, K. (2021). Molecular basis of heterosis and related breeding strategies reveal its importance in vegetable breeding. Horticulture research, 8(1), 1-17; Jorrin Novo, J. V. (2021). Proteomics and plant biology: contributions to date and a look towards the next decade. Expert Review of Proteomics, 18(2), 93-103].

In fact, each individual “omics” approach elucidates a portion of physiological responses. Therefore, the only solution to comprehensively understand and characterize the complexity of secondary metabolism, which involves volatile and non-volatile molecules that are part of the vanilla flavour, is the application of an “omics” approach [Shi, J., Wang, J., Lv, H., Peng, Q., Schreiner, M., Baldermann, S., & Lin, Z. (2021). Integrated proteomic and metabolomic analyses reveal the importance of aroma precursor accumulation and storage in methyl jasmonate-primed tea leaves. Horticulture Research, 8(1), 1-14].

The term proteome is related to the complete characterization of the protein repertoire expressed by a genome, from a single sample [Wilkins, M. R., C. Pasquali, R. D. Appel, K. Ou, O. Golaz, J. C. Sanchez, J. X. Yan, A. A. Gooley, G. Hughes, I. Humphery-Smith, K. L. Williams & D. F. Hochstrasser. (1996). From proteins to proteomes: large scale protein identification by two-dimensional electrophoresis and amino acid analysis. Bio. Technology (NY) 14, 61-65; Wilkins, M. R., J. C. Sanchez, A. A. Gooley, R. D. Appel, I. Humphery-Smith, D. F. Hochstrasser & K. L. Williams. (1995). Progress with proteome projects: why all proteins expressed by a genome should be identified and how to do it. Biotechnol. Genet. Eng. Rev. 13, 19-50]. Proteomics is a useful platform for characterizing cells and tissues of interest, through the identification of protein structures, their functions and their expression levels. This post-genomic approach offers a unique view of biological systems that cannot be provided by genomic or transcriptomic approaches alone. This is possible because there are many more proteins than protein-coding genes [Wienkoop, S. A., S. Baginsky & W. Weckwerth. (2010). Arabidopsis thaliana as a model organism for plant proteome research. Journal of Proteomics 73, 2239-2248]. Therefore, proteomics focuses on the functionality of the translated portion of the genome. [Sarsaiya, S., Shi, J., & Chen, J. (2019). Bioengineering tools for the production of pharmaceuticals: current perspective and future outlook. Bioengineered, 10(1), 469-492; Jorrin Novo, J. V. (2021). Proteomics and plant biology: contributions to date and a look towards the next decade. Expert Review of Proteomics, 18(2), 93-103].

Among the main tools used in proteome analysis is one- and two-dimensional gel electrophoresis (2-DE) [Williams, E. A., J. M. Coxhead & J. C. Mathers. (2003). Anticancer effects of butyrate: use of micro-array technology to investigate mechanisms. Proc. Nutr. Soc. 62, 107-115]. Differentially expressed proteins can be further identified by mass spectrometry methods [Marouga, R., David, S., & Hawkins, E. (2005). The development of the DIGE system: 2D fluorescence difference gel analysis technology. Analytical and bioanalytical chemistry, 382(3), 669-678]. Analysis by gel-free liquid chromatography in conjunction with mass spectrometry (LC-MS/MS), called shotgun proteomics [Leitner, A. & W. Lindner (2009). Chemical Tagging Strategies for Mass Spectrometry-Based Phosphoproteomics. pp. 229-243. In: M. de Graauw [ed.]. Humana Press; Nice, E. C. (2021). The separation sciences, the front end to proteomics: An historical perspective. Biomedical Chromatography, 35(1), e4995], can increase the ability to detect the number of different proteins that can be identified from complex samples compared to more traditional gel-based approaches. Shotgun proteomics has become the method of choice for analyzing complex protein mixtures [Gerster, S. E. Qeli, C. H. Ahrens & P. Bühlmann, 2010. Protein and gene model inference based on statistical modeling in k-partite graphs. Proceedings of the National Academy of Sciences, 107, 12101-12106; Heck, M., & Neely, B. A. (2020). Proteomics in non-model organisms: A new analytical frontier. Journal of proteome research, 19(9), 3595-3606].

Changes in genes and, consequently, protein expression are typically followed by changes in the levels of various secondary metabolites. Compared to genomics (nucleic acids) and proteomics (peptides and proteins), metabolomics addresses a more chemically diverse range of compounds. Large variations in the relative concentrations of metabolites make metabolite analysis more complicated. The metabolome (a complex set of small molecules of an organism) is a biochemical manifestation of the genome and proteome and is also modulated by the functions of proteins. On the other hand, the metabolome can modulate gene expression and protein functions. Therefore, metabolomics plays a fundamental role in understanding cellular systems, defining phenotypes and identifying the function of unknown genes [Allen, J., H. M. Davey, D. Broadhurst, J. K. Heald, J. J. Rowland, S. G. Oliver & D. B. Kell. (2003). High-throughput classification of yeast mutants for functional genomics using metabolic footprinting. Nature Biotechnology 21, 692-696; Süntar, I., Çetinkaya, S., Haydaroğlu, Ü. S., & Habtemariam, S. (2021). Bioproduction process of natural products and biopharmaceuticals: Biotechnological aspects. Biotechnology Advances, 107768; Sumner, L. W., Mendes, P., & Dixon, R. A. (2003). Plant metabolomics: large-scale phytochemistry in the functional genomics era. Phytochemistry, 62(6), 817-836; Huang, T., Jiang, Y., Zhang, Y., Lei, Y., & Jiang, G. (2020). Current application of metabolomics in the elucidation of processing mechanisms used in Chinese materia medica: A review. Tropical Journal of Pharmaceutical Research, 19(6), 1321-1327].

Metabolomics is, above all, necessary to determine all metabolites in a plant extract. To capture all metabolites present in an organism, different analytical platforms can be combined, as plant metabolites have different chemical properties. Their differences are based on the degree of volatility, polarity and concentration in a given tissue. Specifically, for vanillas this is extremely relevant, since many molecules are part of the flavour and some of these molecules are in very low concentration. [Weckwerth, W. (2003). Metabolomics in systems biology. Annu. Rev. Plant Biol. 54, 669-689; Bedair, M., & Glenn, K. C. (2020). Evaluation of the use of untargeted metabolomics in the safety assessment of genetically modified crops. Metabolomics, 16(10), 1-15; Razzaq, A., Sadia, B., Raza, A., Khalid Hameed, M., & Saleem, F. (2019). Metabolomics: A way forward for crop improvement. Metabolites, 9(12), 303].

As mentioned above, the risks of extinction of Vanilla planifolia create a global tendency to seek new sources of vanillin and other equivalent flavours, from the consumer's sensory point of view. In this sense, it would be interesting not only to find or genetically create alternative sources of this main compound, vanillin, but it would be even more important to find or develop other orchids that could be sources not only of vanillin, but of new metabolomic profiles, promoting new flavouring agents that, in combination or not with vanillin, may be capable of developing more attractive, healthy, innovative and safe compositions and products for the human diet.

### SUMMARY OF THE INVENTION

The present invention therefore provides for the development of new compositions containing extract(s), their fractions and their mixtures derived from vanillas from the Brazilian Atlantic Forest and similar regions, which have a metabolomic profile different from those found in the prior art, now having the function of aromatising and flavouring agents, as they present unique organoleptic characteristics and, therefore, generate new compositions of aromatic and volatile compounds, proven by proteomics, metabolomics and sensory studies.

These agents can be used to manufacture other compositions or final products in the flavour, food, pharmaceutical, nutraceutical, cosmetic industries and sectors that make use of the properties, functionalities and bioactivity of the components found in their extracts and fractions, giving the final product an unprecedented and unexpected composition.

Thus, in a first embodiment of the invention, agents and compositions are presented formed by the presence of an aromatically effective amount of extract from a specific and natural vanilla, originating from the Brazilian Atlantic Forest, similar biomes and adjacent regions and their hybrids, its fractions, mixtures with other orchids and even extracts of this vanilla containing genetic modifications, with the aim of amplifying the production of vanillin and/or other compounds of interest. A set of elements that function as: vehicles, additives, thickeners, preservatives, foaming or anti-foaming agents and/or any other element characteristic of the desired final composition will be added to the extracts described above, these being pharmaceutically acceptable, adapted to cosmetics, accepted in human nutrition and/or within the purity and purification parameters indicated by the legislation of the place of production and commercialization.

Since more than 300 molecules have been identified from cured Vanilla fruit extracts, and this number continues to increase, [Maruenda, H., Vico, L., Householder, J. E., Janovec, J. P., Cañari, C., Naka, A., & Gonzalez, A. E. (2013). Exploration of Vanilla pompona from the Peruvian Amazon as a potential source of vanilla essence: Quantification of phenolics by HPLC-DAD. Food Chemistry, 138(1), 161-167; Pérez-Silva, A., Nicolás-García, M., Petit, T., Dijoux, J. B., de los Ángeles Vivar-Vera, M., Besse, P., & Grisoni, M. (2021). Quantification of the aromatic potential of ripe fruit of Vanilla planifolia (Orchidaceae) and several of its closely and distantly related species and hybrids. European Food Research and Technology, 247(6), 1489-1499] and that around twenty-five phenolic compounds can be found, with concentrations greater than 1 mg/kg, identified as responsible for the characteristic aroma and flavour of vanilla, the present invention presents a comparison between the components existing in the two target species of vanilla by this invention and the components already described in the prior art.

Among the components most frequently described in the prior art, we have: vanillin, vanillic alcohol (or vanillyl alcohol), vanillic acid, p-hydroxybenzyl alcohol, p-hydroxybenzaldehyde, p-hydroxybenzoic acid, anisyl alcohol, anisaldehyde and anisic acid. These compounds tend to accumulate in fruits as odorless glycosides [Havkin-Frenkel, D., French, J. C., Graft, N. M., Pak, F. E., Frenkel, C., & Joel, D. M. (2004). Interrelation of curing and botany in vanilla (Vanilla planifolia) bean. Acta horticulturae, 93-102]. Its hydrolysis, carried out by β-glucosidases activated during the initial stages of the curing process, produces the key aromatic aglycones [Maruenda et al., 2013; Pérez-Silva, 2021].

The present invention was able to recognize, through mass spectrometry techniques, the metabolic profile of three Brazilian species, verifying that they are metabolically different from the components described above and consequently from V. planifolia and each other.

Unexpectedly, it was observed that the profile of its metabolome is different, in qualitative and quantitative terms, to the species commercially used and widely described in the prior art.

In this sense, the composition of the present invention has as its main element(s) extract(s) of V. chamissonis and/or V. cribbiana and/or V. bahiana, pure or mixed, originating from the biodiversity of the Atlantic Forest, representing a new source of vanilla essence, but with different content and properties and superior quality.

Since there is a complete lack of knowledge about the chemistry of vanilla species from the Atlantic Forest, compared to that of other regions of the world [Pérez-Silva, 2021], the result of the metabolomics studies of the present invention is surprising, making the compositions and products derived from its extracts unique. Since the extract fractions and their mixtures produce novel aromatising and flavouring agents due to the variety of chemical compounds found only in these vanillas.

A second embodiment of the present invention refers to the method of producing vanilla extracts, aiming to preserve the compounds of interest in the extract fraction, which will make the final compositions different from those described in the prior art and sold on the market. Optionally, performing classical selection, genetic improvement and/or hybrids to modulate the expression of compounds of interest. In general, the process can be summarized in the following steps: 1—pollinating flower; 2—collecting the fruit; 3—curing the fruits or not, processing the fruits or not, grinding, slicing, crushing the fruits or not; 4—preparing of extracts with different solvents (methanol, ethanol, grain alcohol, water, glycerin, isopropanol, among others—preferably solvents permitted for human use) by infusion and/or maceration and/or percolation and/or distillation and/or decoction and/or digestion and/or by supercritical fluid and/or by countercurrent and/or assisted by microwaves and/or assisted by ultrasonication or other techniques, which may be cold or hot; 5—Filtering the extracts or not (separation of residues from the liquid) or clarification by subsidence or not; 6—Obtaining dry extracts (for example: powdered vanilla extract, which can be mixed with sugar and/or starch or other substances), or in an appropriate concentration (for example, more or less liquid extract) such as production of extract (with, for example, water and/or alcohol and/or isopropanol and/or glycerin and/or sugar and/or thickeners and/or corn syrup and/or propylene glycol and/or maltodextrin) or vanilla essence (more concentrated extract by vacuum distillation or other extract volume reduction techniques).

Vanilla extracts can be used as a flavour in the food industry and as a fragrance in the cosmetic industry. Application—Food Processing, Cosmetics, Medical Care and others. Distribution channels—includes hypermarkets and supermarkets, specialized food stores, pharmacies, cosmetics discount stores and others. In this sense, the third and final modality of this invention refer to the use of extracts and their mixtures to manufacture compositions that will function as aromatising and flavouring agents, and their subsequent compositions and final products in industry in general. For example, use in the production of compositions and food products and their derivatives, cosmetic and cosmeceutical products, pharmaceuticals and nutraceuticals, room aromatising agents, insect repellents, among others.

In other words, the compositions of aromatising and flavouring agents (flavouring) proposed here use novel and optionally modified or selected extracts and extract fractions, to serve as the main active ingredient or adjuvants in compositions and products that are intended to replace traditional vanilla essences and/or add more flavour and aroma by serving as an additive, enhancing the resulting aroma or flavour.

### DETAILED DESCRIPTION OF THE INVENTION

The present invention therefore describes FLAVOURING AGENT, COMPOSITION, PRODUCTION PROCESS AND USE OF AROMATISING AND FLAVOURING AGENTS BASED ON VANILLA EXTRACTS from the Brazilian Atlantic Forest, adjacent regions and biomes that have similar climates and microclimates, the natural composition being different from that of traditional vanillas, enabling hybridization, genetic modifications, and can be used alone or together with other extracts or fractions, to obtain flavours that present innovative sensorial and organoleptic profiles.

More specifically, the present invention is based on a sensorially effective amount of a mixture of extracts and fractions of extracts originating from wild, domesticated, hybridized and/or genetically modified vanilla fruits originating from the biodiversity of the Brazilian Atlantic Forest and similar biomes or adjacent, with similar climate, microclimate and/or Terroir effect, containing a metabolomic profile, molecules and/or proportion of substances representative of the region's chemotypes. Knowing that chemotype is an infraspecific and chemically distinct category in a species, presenting different chemical phenotypes.

The present invention, therefore, is based on the extract of Vanilla species, not commercially exploited, which presented metabolomes with a chemical and organoleptic profile different from Vanilla planifolia, for use as aromatising and flavouring agents, to individually or even their mixtures, allow the production of flavour or aroma agents which, together with vehicles, thickeners and other basic components of different types of pharmaceutical, cosmetic, food and cosmeceutical compositions, form a final composition with improved and unexpected results.

From studies carried out by the group of the present invention, it was observed that Vanilla Bahiana, for example, demonstrated great potential to be a natural and alternative source of vanilla flavouring agent. Since expressions of some of the most important enzymes of the vanillin production biosynthetic pathway were found, such as: ACC synthase, 2 chalcone-flavonone isomerase, PAL, OMTs and vanillin synthase [Lopes, Ellen Moura, Roberta Gomes Linhares, Lucas de Oliveira Pires, Rosane Nora Castro, Gustavo Henrique Martins Ferreira Souza, Maria Gabriela Bello Koblitz, Luiz Claudio Cameron, and Andrea Furtado Macedo. “Vanilla bahiana, a contribution from the Atlantic Forest biodiversity for the production of vanilla: A proteomic approach through high-definition nanoLCIMS.” Food Research International 120 (2019): 148-156], in addition to the presence of vanillin itself in the fruit of this orchid, proving that there is a possibility of finding replacement plants for V. planifolia. However, it was not possible to predict its potential use without deeper studies that would prove the novelty of its composition, since replacing the traditional essence is an old quest with high volumes of investment, still unsuccessful, in the food industry. In this way, the results only served to encourage more complex studies with this and other orchid specimens from the Atlantic Forest.

In the Brazilian Atlantic Forest, the group of inventors of the present invention points out three species of Vanilla recognized by the group of the present invention as having the potential for producing vanilla extract: V. chamissonis and/or V. cribbiana and/or V. bahiana.

The present invention is based on the proof that these orchids present novel vanilla aroma compounds or even different concentrations of compounds, due to the expression of proteins possibly related to the metabolism of these compounds. The proteomic analysis performed was able to characterize the complete protein repertoire expressed by a genome and focuses on the functionality of the translated portion.

Knowing that the metabolome is a biochemical manifestation of the genome and the proteome and is also modulated by the functions of proteins, the present invention carried out unprecedented mass spectrometry studies for these species, analyzing their metabolic profile and verifying whether they are metabolically diverse from V. planifolia and from each other.

In other words, the Atlantic Forest environment induces different compositions of orchid fruits from this type of biome, making products that use extracts from Vanilla bahiana, V. cribbiana and/or V. chamissonis unprecedented, all occurring naturally in the Atlantic forest.

For proteomic analysis, the peptides obtained were analyzed on a nanoUPLC Synapt G2-S HDMS instrument, with ion mobility. The mass spectra obtained were used in the identification and quantification of proteins. For qualitative and semi-quantitative metabolomic analysis, an enzymatic extraction methodology to simulate the fruit curing process was used, in parallel to methanolic extraction. Triplicates of 100 mg of a pool of 3 fruits of each species were macerated in liquid N2, each representing a biological replicate, until they formed a fine, clear powder. Enzymatic treatment (ET) followed an adapted protocol based on the cited publications: Ranadive, 1992; Francisco Ruiz-Terán, Perez-Amador, & López-Munguia, 2001. The macerated powder was diluted and vortexed with 600 μL of 0.05 M citrate-phosphate buffer pH 5, which was prepared with citric acid (0.1 M) and dibasic sodium phosphate (0.2 M). The β-glucosidase enzyme (1 mg mL−1) was prepared with the same buffer and 1 mL of this stock solution was added to each sample. The mixture was subjected to incubation in a water bath at 37° C. for a period of 4 h. After incubation, the samples were stored in a freezer at −80° C. After thawing, the citrate-phosphate buffer was dried in a vacuum centrifuge. Subsequently, methanolic extraction (ME) was carried out with the samples that were subjected to TE and those that were not (also 100 mg of macerated powder from triplicates of each species). Four milliliters of methanol (LC-MS grade) was added to each sample, then vortex mixed and subjected to ultrasound-assisted extraction (UAE) with an ultrasonic probe (DESRUPTOR 500W, Ultronique) for 8 min at 80% power. This procedure was repeated three times in total and each time the supernatant was collected and reserved. To prepare for LC-MS/MS analysis, the solvent was evaporated in a vacuum centrifuge (Savant, Thermo Scientific). The dried extracts were then diluted. Methanol, acetonitrile and Milli-Q water (1:1:1, v/v/v) were used to dilute the samples to a concentration of 10 mg mL⁻¹. Then, the same solvents that diluted the samples previously, now with a volume ratio of 1:1:2, up to a concentration of 1 mg mL⁻¹. All samples were filtered with PTFE syringe filters (13 mm pore, 0.22 μm diameter). Quality control (QC) samples were also prepared with 30 μL of each filtered sample in a single vial. To assist in the identification of metabolites, a pool of analytical standards of phenolic compounds was prepared, diluted in triplicates at concentrations 0.001 μg mL⁻¹; 0.01 μg mL⁻¹; 0.1 μg mL⁻¹; 0.5 μg mL⁻¹; 1.0 μg mL⁻¹; 2.5 μg mL⁻¹; 10.0 μg mL⁻¹; 20.0 μg mL⁻¹; 30.0 μg mL⁻¹. The analytical standards used specifically for quantitative analysis and the R2 values corresponding to the calibration curves were: acetovanilone (0.9481), p-hydroxybenzoic acid (0.9902), vanillic acid (0.9879), valinine (0.9915), p-hydroxybenzaldehyde (0.9901). LC-MS/MS acquisition was performed in positive (ESI+) and negative (ESI−) ionization modes. Analyzes were performed on the Dionex Ultimate 3000 UHPLC system coupled to a Q Exactive PlusTM Orbitrap mass spectrometer (Thermo Fisher Scientific, USA). The chromatographic column used was ACQUITY UPLC® BEH C18 130 Å (2.1×100 mm, 1.7 μm particle size) (Waters, United Kingdom). In this way, it was possible to elucidate the proteomic and/or metabolomic profile and quantify important flavour molecules of these three species of the genus Vanilla, characteristic of the Atlantic Forest of Rio de Janeiro, and evaluate the production of vanilla essence compounds, their quality and potential for commercial production.

In this sense, orchids from this region, or from regions with similar climates and microclimates and/or subject to the same Terroir effect, provide a fruit with a different chemical and organoleptic profile, in addition to having the typical vanilla essence molecules used in Marketplace. The three species of Vanilla studied demonstrate that products from compositions containing these agents will generate different and possibly better products in terms of biological and sensorial properties.

As examples of preferred flavouring agents we have:
A. Extract of V. bahiana or extract of hybrids (of V. bahiana with V. chamissionis, or V. bahiana with V. planifolia, or V. bahiana with V. cribbiana or V. bahiana with other Vanillas) pure or in different concentrations and/or forms, mixed with extracts of V. planifolia, V. cribbiana or V. chamissonis, or the aforementioned hybrids, all pure or in different concentrations and/or forms;
B. Extract of V. chamissonis or extract of hybrids (from V. chamissonis with V. bahiana, or V. chamissonis with V. planifolia, or V. chamissonis with V. cribbiana, or V. chamissonis with other Vanilla sp.) or in different concentrations and/or forms, mixed with extracts of V. planifolia, V. bahiana or V. cribbiana or the aforementioned hybrids, all pure or in different concentrations and/or forms;
C. Extract of V. cribbiana or extract of hybrids (of V. cribbiana with V. bahiana, or V. cribbiana with V. planifolia, or V. cribbiana with V. chamissonis, or V. chamissonis with other Vanilla sp.) or in different concentrations and/or forms, mixed with extracts of V. planifolia, V. bahiana or V. chamissonis or the aforementioned hybrids, all pure or in different concentrations and/or forms; and Extracts of items A and/or B and/or C enriched with vanillin or, vanillic alcohol (or vanillyl alcohol), vanillic acid, p-hydroxybenzyl alcohol, p-hydroxybenzaldehyde, p-hydroxybenzoic acid, anisyl alcohol, anisaldehyde, ethyl vanillin and/or anisic acid.

The flavouring agents described above can be obtained by different flavouring compositions, such as:
Natural vanilla aromatising agent—liquid extract with high or low viscosity, obtained from fruits using an extraction solvent (simple or mixed): water, ethanol or isopropanol.
Vanilla Concrete—a semi-solid mixture obtained after extraction, containing fixed, essential oil, fat, fatty acids, waxes, using an azeotropic blend of ethyl acetate and hexane.
Vanilla pomace—a vanilla from which most of the aromatic principles have been extracted and a pomace remains that can be used. The vanilla is ground and reused (nothing in common with vanilla powder).
Vanilla syrup—a mixture of sugar, water and a usually lower concentration of vanilla fruit extract, copying its composition
Vanilla paste—product made with fruit extract in the form of a more or less viscous paste. Used professionally.
Vanilla resin oil—Extraction process identical to that used for vanilla extracts, usually around 3 kg of vanilla fruits are needed to obtain around 1 kg of resin oil (called 30× vanilla). The product obtained may be more or less pasty. Primarily used in the food industry.
Vanilla Absolute—Product derived from the technique described above, but waxes, tannins and other substances still present in the oil resin are removed for an ideal concentration of vanillin. Primarily used in the perfume industry.
Vanilla-vanillin extract (as a aromatising agent or powder)—This is a vanilla extract to which one ounce of vanillin has been added for every 1 fold of vanilla extract (each fold must correspond to 13.35 original ounces (378 g) of fruit in the initial extract before concentration, with no more than 25% moisture content, per gallon (3.78 L) of final extract, therefore, a “two-fold” would have the extractable of 26.7 ounces of larger “Folds”, such as 10× or 20×, are made by diluting oil resins, which do not contain solvent). It has an alcohol content of no less than 35%. A aromatising agent contains less than 35% alcohol. The powders contain a constituent of vanilla (extractive matter from 13.35 ounces of fruit) plus 1 ounce of vanillin in 8 pounds of dry mix. These products are labeled as “natural and artificial flavour”.
Vanilla concentrate—3-fold (3×) alcoholic extract of vanilla obtained by vacuum distillation.
Vanilla powder—a mixture of ground vanilla fruits and/or vanilla oleoresin combined with carbohydrate carriers and flowing agents. One powder contains one vanilla constituent per 8 pounds of product.

More specifically, in the case of metabolomics, the column used was selected based on the best selectivity for the classes of compounds to be analyzed. The separation gradient was carried out with mobile phases composed of the solvents (A) 0.1% formic acid in Milli-Q water and (B) 0.1% formic acid in acetonitrile, at a flow rate of 0.35 mL. Elution was carried out with a gradient: 0-1 min B 5%, 1-3 min B 5-35%, 3-13 min B 35-95%, 13-15 min B 95%, 15-15.1 min B 5%, 15.1-18 min B 5%. The injection volume was 5 μL. All these parameters are described for the purpose of illustrating the techniques necessary to determine the biochemical differences between new orchids and those previously existing in the state of the art as having commercial value. The parameters of this analysis were gradually optimized from one experiment to another, for better discrimination and separation performance, quantification and identification of compounds. The processing of mass spectra was carried out in this experiment using MS-DIAL software [Tsugawa, H., Cajka, T., Kind, T., Ma, Y., Higgins, B., Ikeda, K., Kanazawa, M., VanderGheynst, J., Fiehn, O. and Arita, M. (2015). MS-DIAL: data-independent MS/MS deconvolution for comprehensive metabolome analysis. Nature methods, 12(6), pp. 523-526] e MS-FINDER [Lai, Z., Tsugawa, H., Wohlgemuth, G., Mehta, S., Mueller, M., Zheng, Y., Ogiwara, A., Meissen, J., Showalter, M., Takeuchi, K. and Kind, T., (2018). Identifying metabolites by integrating metabolome databases with mass spectrometry cheminformatics. Nature methods, 15(1), pp. 53-56.] for metabolomics. An untargeted approach was applied focusing on identifying molecules related to vanilla flavour, as well as unknown molecules and, more generally, chemical classes. Using this approach, the reliability of molecule identification increases according to the fulfillment of certain prerequisites, namely, mass accuracy (level 5), isotopic distribution (level 4), tentative structure (level 3), fragment compatibility experimental studies with fragment databases (level 2) and compatibility with analytical standards (level 1) [Schrimpe-Rutledge A C, Codreanu S G, Sherrod S D, McLean J A. Untargeted metabolomics strategies—challenges and emerging directions. Journal of the American Society for Mass Spectrometry. 2016 Sep. 13; 27(12):1897-905.]. The results presented here meet all prerequisites and present levels 1 (called identifications), 2 (called annotations).

More specifically in the case of proteomics, the fresh fruits were macerated in liquid nitrogen. The resulting powder was placed in a 10% trichloroacetic acid (TCA) solution in acetone overnight. After centrifugation at 16000 g/30 min/4° C., the pellet was washed with acetone+0.07% β-mercaptoethanol solution, incubated at −20° C./1 h (3×). The resulting pellet was resuspended in a solution with 0.1% RapiGest in 100 mM ammonium bicarbonate 15 min/80° C. After sonication of the protein extract, centrifugation was performed at 16000 g/30 min./4° C. Part of the supernatant was used for protein quantification using the BCA Kit (Pierce® BCA Protein Assay Kit) and part was treated with DTT 5 mM/30 min./60° C. The protein solution treated with DTT was cooled until it reached room temperature, when 10 mM iodocetamide/30 min/dark was added. Then, the proteins were incubated overnight with trypsin (1:50 (v/v)) at 37° C. Subsequently, 0.5% (v/v) TFA, pH 2.0, was added to the solution with peptides and the material was incubated at 37° C. for 90 min. After centrifugation (14000 g/30 min/6° C.), the supernatant was evaluated by LC/MS. The peptides obtained, after enzymatic treatment, were analyzed on a nanoUPLC Synapt G2-S HDMS instrument (Waters, Manchester, UK), with orthogonal effective resolution based on ionic mobility to differentiate peptides by mass, charge state and conformation. The mass spectra obtained through detections in Synapt were used in the identification and quantification of proteins. The PROGENESIS QI for Proteomics software (v1.0.5156.29278) was used for this purpose as it contains the Vanilla (Orchidaceae family) protein database (UNIPROT—http://www.uniprot.org). Within the variability, the identified proteins, which occur mainly in fruit samples, were grouped according to their main cellular functions using the UNIPROT program.

It should be noted that this is just an example of analysis, since other less selective proteomic techniques can and have been used as needed in the studies, such as gel electrophoresis followed by mass spectrometry analysis. Different ways of analyzing the biochemical composition of these plants do not alter or differentiate the scope of the present invention.

Based on proteomics and metabolomics data from Vanilla bahiana—VB, Vanilla chamissonis—VC and Vanilla cribbiana—VCB, it was possible to correlate the identity of metabolites with compounds known to be related to the flavour and aroma of commercial vanilla from V. planifolia—VP [Pérez-Silva, A., Odoux, E., Brat, P., Ribeyre, F., Rodriguez-Jimenes, G., Robles-Olvera, V., . . . Günata, Z. (2006). GC-MS and GC-olfactometry analysis of aroma compounds in a representative organic aroma extract from cured vanilla (Vanilla planifolia G. Jackson) beans. Food Chemistry, 99(4), 728-735. https://doi.org/10.1016/j.foodchem.2005.08.050; Perez de Souza, L., Alseekh, S., Naake, T., & Fernie, A. (2019). Mass Spectrometry-Based Untargeted Plant Metabolomics. Current Protocols in Plant Biology, 4(4), e20100. https://doi.org/10.1002/cppb.20100; Ranadive, A. S. (1992). Vanillin and Related Flavour Compounds in Vanilla Extracts Made from Beans of Various Global Origins. Journal of Agricultural and Food Chemistry, 40(10), 1922-1924; Pérez-Silva, A., Nicolás-Garcia, M., Petit, T., Dijoux, J. B., de los Angeles Vivar-Vera, M., Besse, P., & Grisoni, M. (2021). Quantification of the aromatic potential of ripe fruit of Vanilla planifolia (Orchidaceae) and several of its closely and distantly related species and hybrids. European Food Research and Technology, 247(6), 1489-1499].

In more recent, 2021, unpublished studies carried out by the group of the present invention, it was possible to putatively determine the total composition of the same species (VP, VC and VB), which demonstrate that the difference cannot be defined by the presence or absence of metabolites, but due to the complex total composition and their relative quantifications, as shown in Table 1, below. In one of these studies, it was possible to quantify important compounds for vanilla flavour, comparing the 4 species (VP, VB, VC, VCB) as shown in Table 2, below.

In one of the aforementioned studies, 2,273 ion signals were detected in ESI− and 1,251 in ESI+ of all three species (VB, VC and VP). Of these, a total of 63 compounds were noted from both ionization modes. Only vanillin was observed simultaneously in both modes (Table 1). Molecule identification was more effective in ESI−, with 47 compounds, as opposed to 16 in ESI+. The implementation of the positive and negative ionization modes strategy was designated here for its potential to reveal a more global perspective [Perez de Souza, Alseekh, Naake, & Fernie, 2019], with the aim of contemplating a wider range of metabolites of high molecular diversity matrix of the three species.

TABLE 1
Compounds noted and respective detection intensities described based on the height
of the chromatographic peaks for each species of Vanilla sp. by LC-ESI-MS/MS
after methanolic extraction in samples submitted or not to enzymatic treatment (TE).
VB—Bahian vanilla; VC—Vanilla chamissonis; VP—Vanilla planifolia.
ESI−, negative ionization mode; ESI+, positive ionization mode.

| Metabolite | m/z | VB TE | VB | VC TE | VC | VP TE | VP | ESI |
|---|---|---|---|---|---|---|---|---|
| (2R,3S)-2,3- | 143.0341 | 1.08E+07 | 2.75E+06 | 2.48E+07 | 2.06E+07 | 1.48E+07 | 4.50E+06 | − |
| dimethylmalic acid | | | | | | | | |
| (S)-4-hydroxy-2- | 187.0238 | 1.01E+09 | 3.50E+08 | 8.11E+08 | 5.36E+08 | 1.20E+09 | 1.01E+09 | − |
| oxoheptanedioate | | | | | | | | |
| 10-dehydrogardenoside | 401.1101 | 1.87E+04 | 1.93E+04 | 7.42E+04 | 3.91E+04 | 2.26E+06 | 8.97E+06 | − |
| 10-deoxygeniposidic | 357.1197 | 2.00E+04 | 8.85E+06 | 0 | 0 | 2.78E+05 | 1.71E+06 | − |
| acid | | | | | | | | |
| 1-O-p-coumaroyl-beta- | 325.0927 | 3.04E+05 | 3.35E+04 | 2.54E+06 | 2.82E+06 | 5.43E+04 | 8.14E+06 | − |
| D-glucose | | | | | | | | |
| 1-O-sinapoyl glucose | 404.1546 | 6.99E+08 | 5.82E+08 | 1.47E+09 | 4.65E+09 | 6.64E+06 | 5.42E+06 | + |
| 1-O-vaniloyl-beta-D- | 329.0884 | 4.33E+04 | 3.74E+05 | 3.73E+04 | 9.53E+04 | 3.48E+05 | 6.37E+07 | − |
| glucose | | | | | | | | |
| 2,7-dihydroxy-1-(4- | 361.1080 | 2.46E+07 | 8.11E+06 | 4.12E+05 | 3.02E+05 | 7.42E+06 | 2.92E+07 | − |
| hydroxybenzoyl)4- | | | | | | | | |
| methoxy-9,10- | | | | | | | | |
| dihydrophenanthrene | | | | | | | | |
| 2-isopropylmalic acid | 175.0602 | 1.02E+07 | 2.45E+06 | 2.26E+07 | 1.86E+07 | 2.73E+06 | 4.88E+05 | − |
| 3-acryloyloxypropionic | 143.0341 | 2.17E+07 | 7.41E+06 | 2.22E+07 | 1.49E+07 | 2.77E+07 | 2.11E+07 | − |
| acid | | | | | | | | |
| 4- | 121.0283 | 2.05E+07 | 1.02E+07 | 1.97E+07 | 1.73E+07 | 4.91E+08 | 2.88E+08 | − |
| hydroxybenzaldehyde | | | | | | | | |
| (p- | | | | | | | | |
| hydroxybenzaldehyde) * | | | | | | | | |
| 4-vinylguaiacol | 151.0752 | 2.56E+05 | 5.31E+04 | 1.25E+07 | 1.39E+07 | 1.97E+04 | 1.97E+04 | + |
| 4-vinylphenol | 138.0913 | 8.49E+06 | 6.43E+06 | 3.34E+05 | 5.79E+05 | 2.11E+06 | 1.19E+07 | + |
| 5,7-dihydroxy-2-(3- | 329.0671 | 7.27E+05 | 1.50E+05 | 1.91E+04 | 3.21E+06 | 3.15E+06 | 1.53E+05 | − |
| hydroxy-4-methoxy- | | | | | | | | |
| phenyl)-3-methoxy- | | | | | | | | |
| chromone | | | | | | | | |
| 5-hydroxymethyl-2- | 127.0389 | 6.05E+06 | 8.34E+06 | 7.52E+06 | 1.35E+07 | 8.07E+06 | 2.41E+07 | + |
| furancarboxaldehyde | | | | | | | | |
| 6-O-alpha-L- | 507.1724 | 3.06E+06 | 4.55E+06 | 3.59E+06 | 2.26E+07 | 4.62E+06 | 0 | − |
| rhamnopyranosylcatalpol | | | | | | | | |
| 7-hydroxy-2-methyl-4- | 233.0432 | 1.99E+05 | 3.86E+04 | 8.85E+05 | 6.94E+05 | 4.61E+04 | 0 | − |
| oxo-4H-1-benzopyran-5- | | | | | | | | |
| acetic acid | | | | | | | | |
| acetovanilone | 165.0548 | 1.66E+07 | 2.51E+07 | 1.15E+06 | 1.08E+06 | 8.40E+05 | 4.42E+06 | − |
| alpinumisoflavone | 337.1073 | 6.86E+06 | 7.47E+06 | 1.24E+04 | 4.50E+04 | 1.34E+05 | 1.18E+06 | + |
| apiopeonoside | 459.1515 | 1.26E+05 | 2.60E+07 | 7.23E+04 | 6.34E+05 | 4.58E+06 | 5.50E+07 | − |
| arbutin | 317.0874 | 6.31E+04 | 3.21E+06 | 0 | 1.15E+05 | 3.93E+05 | 9.27E+06 | − |
| bletilol A | 491.1726 | 2.44E+05 | 1.53E+05 | 5.34E+06 | 3.65E+06 | 1.01E+06 | 5.46E+06 | − |
| catechin | 289.0722 | 3.38E+06 | 3.12E+03 | 1.49E+07 | 1.73E+07 | 9.40E+05 | 1.27E+04 | − |
| cinchonain 1a | 451.1042 | 1.94E+04 | 1.17E+04 | 2.16E+04 | 6.70E+06 | 6.55E+06 | 5.55E+04 | − |
| cinnamaldehyde | 133.0650 | 4.22E+07 | 9.30E+06 | 1.32E+04 | 2.85E+04 | 5.52E+04 | 8.85E+05 | + |
| citramalic acid | 147.0289 | 4.64E+06 | 1.19E+06 | 8.67E+06 | 5.06E+06 | 3.73E+06 | 1.50E+06 | − |
| coelovirin A or B | 473.1659 | 3.22E+05 | 4.34E+07 | 5.38E+04 | 6.87E+05 | 1.12E+07 | 1.43E+08 | − |
| D-arabinose | 149.0444 | 8.91E+06 | 9.29E+06 | 1.14E+07 | 1.44E+07 | 8.46E+06 | 5.42E+06 | − |
| D-glucose | 179.0554 | 1.78E+08 | 4.69E+07 | 3.85E+08 | 3.31E+08 | 2.40E+08 | 7.63E+07 | − |
| dracunculifoside J | 430.1708 | 9.97E+04 | 2.47E+05 | 8.70E+06 | 9.59E+06 | 5.82E+04 | 9.11E+04 | + |
| galactosylglycerol | 253.0928 | 3.51E+05 | 2.73E+06 | 6.00E+05 | 4.29E+06 | 6.27E+06 | 0 | − |
| gibberellin A3 | 345.1352 | 9.59E+06 | 6.51E+06 | 2.06E+05 | 2.05E+05 | 4.62E+04 | 6.29E+05 | − |
| glucosyringic acid | 359.0991 | 3.11E+04 | 6.10E+04 | 1.74E+04 | 1.85E+05 | 2.16E+06 | 1.67E+09 | − |
| glycovanillin | 313.0935 | 0 | 0 | 0 | 2.82E+06 | 2.63E+06 | 6.88E+06 | − |
| homoeriodictyol | 301.0717 | 2.69E+05 | 8.76E+05 | 2.61E+06 | 1.15E+06 | 5.33E+07 | 4.08E+06 | − |
| icariside D2 | 323.1101 | 1.93E+07 | 2.96E+08 | 5.46E+07 | 4.57E+08 | 1.86E+05 | 8.50E+05 | + |
| L-arginine | 175.1188 | 6.88E+06 | 1.18E+06 | 8.97E+07 | 8.09E+07 | 1.53E+06 | 9.33E+05 | + |
| L-histidine | 156.0765 | 3.30E+07 | 6.16E+06 | 2.23E+06 | 1.21E+06 | 6.74E+05 | 3.50E+05 | + |
| L-phenylalanine | 166.0862 | 1.82E+06 | 2.67E+05 | 1.25E+06 | 7.85E+05 | 3.11E+06 | 6.19E+05 | + |
| luteolin 7-glucoside-4′- | 529.1408 | 1.14E+07 | 4.06E+06 | 1.37E+07 | 2.04E+07 | 9.33E+06 | 3.16E+07 | − |
| (Z-2-methyl-2- | | | | | | | | |
| butenoate) | | | | | | | | |
| methyl benzoate | 137.0595 | 2.19E+05 | 1.81E+05 | 8.17E+05 | 1.42E+06 | 2.64E+06 | 1.21E+07 | + |
| nevadensin | 343.0830 | 4.68E+06 | 1.02E+06 | 1.53E+05 | 2.96E+05 | 2.25E+05 | 1.65E+05 | − |
| newbouldioside A | 773.2527 | 6.64E+04 | 1.58E+08 | 8.08E+06 | 2.24E+06 | 1.83E+08 | 2.72E+08 | − |
| oleic acid | 281.2491 | 4.55E+06 | 7.27E+06 | 2.66E+06 | 1.29E+04 | 3.00E+06 | 3.02E+04 | − |
| paeonoside | 327.1087 | 1.13E+04 | 3.90E+06 | 3.93E+06 | 4.07E+04 | 6.15E+04 | 8.78E+06 | − |
| phenylacetaldehyde | 121.0649 | 1.18E+08 | 1.91E+07 | 4.22E+08 | 5.38E+08 | 3.32E+05 | 2.42E+05 | + |
| 4-hydroxybenzoic acid | 137.0235 | 6.44E+07 | 3.17E+07 | 1.24E+08 | 7.49E+07 | 1.80E+08 | 3.39E+07 | − |
| (p-hydroxybenzoic | | | | | | | | |
| acid) * | | | | | | | | |
| p-hydroxycinnamic acid | 163.0393 | 2.52E+07 | 1.53E+07 | 1.78E+06 | 1.16E+06 | 1.24E+07 | 7.90E+06 | − |
| plumierid | 469.1361 | 1.68E+05 | 1.57E+05 | 4.64E+06 | 5.92E+06 | 3.63E+05 | 1.22E+04 | − |
| protocatechuic acid | 153.0186 | 2.60E+05 | 1.47E+05 | 4.14E+05 | 3.53E+05 | 3.92E+05 | 8.30E+04 | − |
| pseudolaroside A | 299.0777 | 1.16E+05 | 1.42E+06 | 7.68E+04 | 1.78E+05 | 1.79E+06 | 1.98E+07 | − |
| quinic acid | 191.0555 | 7.34E+05 | 1.08E+06 | 1.18E+05 | 5.92E+06 | 2.93E+05 | 9.32E+06 | − |
| rhodioloside | 318.1540 | 1.35E+07 | 2.21E+08 | 4.06E+07 | 2.48E+08 | 3.78E+05 | 1.45E+06 | + |
| sibiricosa A1 | 547.1685 | 1.30E+05 | 2.73E+05 | 9.50E+05 | 6.49E+06 | 1.30E+04 | 3.19E+04 | − |
| tectoridine | 461.1032 | 3.03E+06 | 4.54E+06 | 2.26E+05 | 2.19E+05 | 1.12E+05 | 6.05E+05 | − |
| tyrosol | 121.0648 | 6.49E+05 | 2.14E+05 | 1.63E+06 | 4.41E+06 | 3.34E+04 | 2.72E+04 | + |
| vanillic acid | 167.0341 | 1.58E+05 | 1.39E+05 | 5.00E+06 | 2.10E+06 | 3.65E+05 | 9.59E+05 | − |
| vanillic acid 4-beta-D- | 329.0883 | 4.39E+04 | 3.04E+05 | 3.27E+04 | 4.93E+05 | 1.05E+07 | 2.37E+07 | − |
| glucoside | | | | | | | | |
| vanillin * | 151.0391 | 7.23E+05 | 9.11E+05 | 1.21E+06 | 1.16E+06 | 4.44E+08 | 3.65E+07 | − |
| vanillin | 153.0546 | 1.24E+05 | 6.81E+06 | 5.97E+05 | 1.10E+06 | 4.01E+07 | 4.27E+06 | + |
| vanillic alcohol | 153.0550 | 3.82E+05 | 2.44E+05 | 1.87E+06 | 4.76E+06 | 1.58E+06 | 2.75E+05 | − |
| verbasoside | 461.1666 | 1.71E+04 | 6.21E+05 | 1.53E+05 | 3.57E+06 | 9.97E+04 | 1.07E+06 | − |
| wyerol | 259.0981 | 1.49E+05 | 9.26E+06 | 7.37E+06 | 1.16E+07 | 3.52E+06 | 2.79E+04 | − |

NOTE:
data acquired through LC-MS/MS of Vanilla bahiana (VB), V. chamissonis (VC) and V. planifolia (VP) submitted or not to enzymatic treatment (TE).
* Molecules confirmed with analytical standar.

TABLE 2
Averages in milligrams (mg) and their standard deviations (+) of the
concentrations of the compounds quantified in relation to 100 g of dry
extract. The compounds were quantified based on the area of the chromatographic
peaks for each species of Vanilla sp. by LC-ESI-MS/MS after methanolic
extraction in samples subjected to enzymatic treatment (TE).

| Metabolite | VB | VC | VCB | VP |
|---|---|---|---|---|
| Acetovanilone | 43.22 ± 0.04 | 40.70 ± 0.04 | 36.65 ± 0.008 | 59.67 ± 0.01 |
| 4-hydroxybenzoic acid | 21.00 ± 0.04 | 13.42 ± 0.05 | 28.53 ± 0.1 | 50.70 ± 0.20 |
| (p-hydroxybenzoic acid) | | | | |
| vanillic acid | — | — | 4.53 | 119.37 ± 053 |
| vanillin | — | — | 2293.87 ± 14.37 | 2686.08 ± 14.63 |
| 4-hydroxybenzaldehyde | — | — | — | 315.32 ± 1.21 |
| (p- | | | | |
| hydroxybenzaldehyde) | | | | |

VB—Vanilla bahiana; VC—Vanilla chamissonis; VP—Vanilla planifolia; VCB—Vanilla cribbiana.

Of the 47 compounds noted in ESI−, 44 compounds were detected simultaneously in all three species (VP, VB and VC) and 2 more compounds present at the same time in only two species together, as described below:
VB and VP shared 10-deoxygeniposidic acid; and
VC and VP exclusively shared the compound glycovanillin.

On the other hand, of the compounds annotated by the ESI+ technique, only 16 compounds were detected. All present simultaneously in the 3 species, which demonstrates that ESI− is more effective in distinguishing between the molecular matrix of each metabolome than ESI+. Three compounds were confirmed through analytical standards: p-hydroxybenzoic acid, p-hydroxybenzaldehyde and vanillin, marked in bold and underlined in Table 1.

Using this method, the molecular intersection of the three vanillas compared, here expressed by the main flavour molecules and other compounds unknown until now for these species (Table 1), suggests that VB and VC produce a close phenotypic configuration and characteristics of commercial species appreciated. However, they also present quantitative variations in their metabolome, relating to the different intensities at which metabolites are detected in each species, indicating a great potential for replacing the predominant aromas on the market, adding a unique sensorial and organoleptic signature. Through quantitative analysis comparing the four species (VB, VC, VCB and VP) (Table 2), it was possible to verify that VCB and VP have a similar amount of vanillin, indicating a great potential for using VCB to replace VP. These data confirm the observation of vanillin crystals on VCB fruits, which reflects a higher quality level for this species.

Flavouring Compounds from Vanillas spp. of the Atlantic Forest

Molecules notably and frequently related to vanilla flavour were identified: vanillin, p-hydroxybenzaldehyde, p-hydroxybenzoic acid, 4-vinylguaiacol, 4-vinylphenol, vanillic acid and vanillic alcohol [Zhang, S., & Mueller, C. (2012). Comparative analysis of volatiles in traditionally cured Bourbon and Ugandan vanilla bean (Vanilla planifolia) extracts. Journal of Agricultural and Food Chemistry, 60(42), 10433-10444. https://doi.org/10.1021/jf302615s]. Other aroma compounds that are not as commonly or not at all described as belonging to commercial vanilla aromas have also been identified herein. FlavourDB and related sources [Garg, N., Sethupathy, A., Tuwani, R., N k, R., Dokania, S., Iyer, A., . . . Bagler, G. (2018). FlavourDB: A database of flavour molecules. Nucleic Acids Research, 46(D1), D1210-D1216. https://doi.org/10.1093/nar/gkx957], were used to correlate these molecules with the flavour or aroma they potentially exert on vanillas. The intensity of presence of such compounds was comparatively analyzed between V. bahiana, V. chamissonis, V. cribbiana and V. planifolia, as follows.

Annotated compounds were associated with their flavour descriptors according to information present in the FlavourDB (https://cosylab.iiitd.edu.in/flavourdb). The flavour descriptors were then associated with the relative intensities of the detected signals of the respective metabolites, as well as the reasons for their respective detections in each vanilla species. The annotation of the following compounds was significantly more intense in VB and VC compared to VP and was associated, respectively, with the following flavour descriptors: catechin (bitter), oleic acid (lard, fat, waxy, fatty, frying, weak), vanillic acid (powdery, vanilla, bean, milky, sweet, creamy, dairy), galactosylglycerol (sweet), tectoridin (sweet), acetovanilone (vanilla, sweet, vanillin, subtle), tyrosol (floral, sweet, fruity, light), phenylacetaldehyde (hyacinth, honey, clover, sweet, hawthorn, cocoa, grapefruit, green, peanut, floral, bitter), cinnamaldehyde (spicy, hot, peppery, red, clove, sweet, sweet, cinnamon), 4-vinylguaiacol (curry, smoky, clove, almond, spicy), L-histidine (bitter) and L-arginine (mild). In a quantitative study, VCB presented statistically similar concentrations of compounds related to the aforementioned descriptors in relation to VP: acetovanilone and vanillic acid. Likewise, VCB was also equivalent to VP in the concentration of vanillin (vanilla, chocolate, sweet, creamy) and 4-hydroxybenzoic acid (nuts, phenolic). The association of molecule annotations with FlavourDB flavour descriptors was due to the fact that the odor descriptor profiles of cured V. planifolia fruits observed using electronic nose techniques are not sufficient given the real complexity of the flavour of this condiment, to be characterized as vanilla, often limiting themselves to the following descriptors: sweet, fruity, floral, harsh, woody, beany, smoky, tobacco-like and fermented [Hariom, B. N., Shyamala, M. P., & Bhat, K. K. (2006). Vanilla flavour evaluation by sensory and electronic nose techniques. Journal of Sensory Studies, 21(2), 228-239. https://doi.org/10.1111/j.1745-459X.2006.00063.x]. Unequivocally, its flavour encompasses a much broader complexity. Perez-Silva and colleagues (2006) reported the identification of 26 volatile compounds belonging to the classes of phenols, aliphatic acids, alcohols, aldehydes, esters and ketones associated with weak, medium and strong odor intensities, as observed in cured vanilla fruits. These volatiles have been associated with 24 distinct odor qualities, including “chemical, spicy sweet” (guaiacol), “sweet, woody” (4-methylguaiacol), “vanilla, sweet, honey” (acetovanilone) and “chalk” (methyl salicylate) were perceived as intensely as the “vanilla, sweet” descriptor of vanillin, while being up to 1,000 times less concentrated (Perez-Silva et al., 2006).

In a recent study already mentioned, 2021, unpublished, carried out by the group of the present invention, the metabolites that characterize the metabolic profile of VB, VCB and VC, associated with potential flavour descriptors and/or potential biotechnological applicability, were described its structural information in the form of detection of m/z signals of precursor ions and their fragments, enabling partial chemical elucidation, as set out in Table 3.

TABLE 3
List of detected molecules that characterize the metabolic profile of VB, VCB and VC, with structural
information in the form of signals from precursor ions (m/z precursor molecular ion) and their
fragments (m/z fragment ions), respective adducts and modes of ionization (ESI).

| m/z precursor | | | |
|---|---|---|---|
| molecular | | | |
| ion | m/z fragment ions | Adducts | ESI |
| 289.0722 | 289.0727; 259.0602; 137.0236; 136.0161 | [M − H]− | − |
| 281.2491 | 281.2505; 213.0154; 1449232 | [M − H]− | − |
| 167.0341 | 167.0338; 149.0238; 123.0442; 121.0282; 93.0332 | [M − H]− | − |
| 253.0928 | 253.0936; 161.0441; 119.0341; 113.0237; 101.0230; 89.0225; | [M − H]− | − |
| | 71.0124; 59.0125 | | |
| 461.1032 | 461.1078; 415.0974; 371.1084; 367.0737; 294.0342 | [M − H]− | − |
| 121.0295 | 121.0309; 108.0229; 93.0353 | [M − H]− | − |
| 137.0244 | 138.0286; 137.0252; 136.0174 | [M − H]− | − |
| 163.0400 | 162.8408; 123.9477; 118.9942; 103.9213 | [M − H]− | − |
| 165.0548 | 165.0554; 147.0442; 135.0436 | [M − H]− | − |
| 175.0602 | 175.0610; 157.0496; 146.9597; 115.0386; 85.0644 | [M − H]− | − |
| 259.0981 | 259.0966; 181.0489; 137.0602; 121.0283 | [M − H]− | − |
| 325.0927 | 325.0957; 265.0717; 187.0240; 143.0343; 125.0237; 99.0436 | [M − H]− | − |
| 343.0830 | 179.0353; 177.0192; 165.0555; 135.0437; 133.0290 | [M − H]− | − |
| 345.1352 | 345.1325; 299.1294; 283.0980; 251.1068 | [M − H]− | − |
| 357.1197 | 357.1172; 311.1108; 149.0599 | [M − H]− | − |
| 469.1361 | 299.1148; 125.0236 | [M − H]− | − |
| 507.1724 | 461.1653; 299.1146; 161.0440 | [M − H]− | − |
| 547.1685 | 503.1761; 461.1653; 299.1141; 161.0437; 101.0228; 71.0125; | [M − H]− | − |
| | 59.0126 | | |
| 318.1540 | 318.1582; 180.0857; 121.0652 | [M + NH₄]+ | + |
| 404.1546 | 217.0156; 121.0654 | [M + NH₄]+ | + |
| 430.1708 | 385.1282; 121.0652; 113.0592; 78.0467 | [M + NH₄]+ | + |
| 323.1101 | 323.1075; 121.0561 | [M + Na]+ | + |
| 121.0648 | 106.0411; 91.0541 | [M + H]₂O]+ | + |
| 121.0649 | 91.0541; 78.0468 | [M + H]+ | + |
| 133.0650 | 105.0702; 103.0548 | [M + H]+ | + |
| 151.0752 | 135.0443; 118.0344; 107.0497 | [M + H]+ | + |
| 153.0546 | 153.0555; 125.0605; 111.0449; 93.0344; 65.0396 | [M + H]+ | + |
| 167.0714 | 167.0717; 144.9664; 120.9814; 102.9714 | [M + H]+ | + |
| 169.0495 | 169.0507; 151.0402; 146.9625; 128.9518; 125.0608; 111.0452 | [M + H]+ | + |
| 175.1188 | 158.0924; 130.0974; 116.0708; 112.0760; 70.0656; 60.0563 | [M + H]+ | + |
| 337.1073 | 337.1073; 243.0639; 201.0534 147.0438; 141.0175; 133.0646 | [M + H]+ | + |
| 156.0765 | 110.0711; 93.0447; 83.0606 | [M + CH₃OH + H]+ | + |

It is clear that vanillas from the Atlantic Forest have all the potential to be alternatives to the flavour of the commercially known spice and to be appreciated in a multitude of industrial applications based on the natural richness of flavours. The results also demonstrate the inherent ability of wild relatives to V. planifolia (V. bahiana, V. cribbiana and V. chamissonis) to contain such desired phenotypic qualities to make them strong candidates for gene donors for elite species.

Given these results, we found that the extracts derived from VB, VCB and VC have a unique composition, giving unique flavours and aromas, in addition to also presenting the main substance, vanillin, and other compounds characteristic of commercial vanilla essence. This can be corroborated with the sensory study (consumer acceptance and sensory characteristics), presented below.

Therefore, both the spectrometric and sensorial studies point to the fact that the vanillas of the present invention can 1) replace vanilla extracts from artificial essence or V. planifolia, 2) present new aromatic profiles of commercial interest. This unexpectedly proves that the chemical heritage of Brazilian biodiversity is a very rich source of biotechnologically applicable models for the global agricultural sector, which can replace or improve traditional extracts on the market. In this context, the genus Vanilla Mill (Orchidaceae) has many species found in Brazilian territory. Among these species, according to the present invention, V. cribbiana appears to have the greatest potential for success as a substitute for V. planifolia on the market. Since the flavour perception threshold was the lowest among the species evaluated (V. planifolia, V. chamisonis, V. bahiana), and V. cribbiana achieved good acceptance rates, not differing statistically from V. planifolia (the most sold species in the world). Additionally, V. cribbiana and V. chamissonis (vanillas native to Brazil) were accepted in a statistically similar way to the commercial sample (V. planifolia). Regarding the descriptive evaluation carried out through the Rate-All-That-Apply (RATA) questionnaire, the “vanilla aroma” of V. cribbiana did not differ statistically from that of the artificial essence tested, and in relation to the “sweet flavour”, it did not differ statistically of V. planifolia, V. chamissonis or the artificial essence tested. V. bahiana, on the other hand, presented a combination of “bitter flavour”, “alcoholic flavour” and “alcoholic aroma”, presenting a sensorial profile statistically different from V. cribbiana and V. chamissonis, having potential for another type of industrial segment, such as drinks, for example.

These results demonstrate that these orchids have great commercial/industrial potential both in the production of vanillin and in the supply of a new flavouring agent with biological and physicochemical properties of interest for the manufacture of cosmetic products, cosmetic, pharmaceutical (compounds, extracts and bioactive fractions, medicinal plants, pharmaceutically acceptable adjuvants and pharmaceutically active ingredients), food (e.g. sweeteners, preservatives, preservatives, essences), aromatic (e.g. perfumery), cosmeceutical compositions and formulations, dermocosmetics, nutraceuticals (e.g.: antioxidants, anti-inflammatory, anti-diabetic, anti-cancer), textile, wooden, plastic articles, among other uses of orchid-based flavourings [Baqueiro-Peña, I., & Guerrero-Beltrán, J. A. (2017). Vanilla (Vanilla planifolia Andr.), its residues and other industrial by-products for recovering high value flavour molecules: A review. Journal of Applied Research on Medicinal and Aromatic Plants, 6, 1-9. https://doi.org/10.1016/j.jarmap.2016.10.003; Cheng, W.-Y., Hsiang, C.-Y., Bau, D.-T., Chen, J.-C., Shen, W.-S., Li, C.-C., Ho, T.-Y. (2007). Microarray analysis of vanillin-regulated gene expression profile in human hepatocarcinoma cells. Pharmacological Research, 56(6), 474-482. https://doi.org/10.1016/j.phrs.2007.09.009; Shyamala, B. N., Madhava Naidu, M., Sulochanamma, G., & Srinivas, P. (2007). Studies on the antioxidant activities of natural vanilla extract and its constituent compounds through in vitro models. Journal of Agricultural and Food Chemistry, 55(19), 7738-7743. https://doi.org/10.1021/jf071349+; Wang, J., Zhang, Y., Fang, Z., Sun, L., Wang, Y., Liu, Y., . . . Gooneratne, R. (2019). Oleic Acid Alleviates Cadmium-Induced Oxidative Damage in Rat by Its Radicals Scavenging Activity. Biological Trace Element Research, 190(1), 95-100. https://doi.org/10.1007/s12011-018-1526-4; Tiwari, T. N., Pandey, V. B., & Dubey, N. K. (2002). Plumieride from Allamanda cathartica as an antidermatophytic agent. Phytotherapy Research, 16(4), 393-394. https://doi.org/10.1002/ptr.967; Kuete, V. (2013). Phenylpropanoids and Related Compounds from the Medicinal Plants of Africa. In Medicinal Plant Research in Africa (pp. 251-260). https://doi.org/10.1016/B978-0-12-405927-6.00007-2].

It is worth noting that the flavouring agents of the present invention can be formed by a single substance, or even be formed by a set of components present in VB and/or in VCB and/or in VC. In other words, the agent can be represented by a single molecule/extract/fraction or by a set of molecules/extracts/fractions, in addition to their mixtures. In this way, said agents may present different formulations to obtain the best flavouring effect, promoting a flavour and aroma similar to the VP extract, or altered/improved aroma and flavour.

Adicionalmente, o agente flavourizante obtido acima pode ser combinado com elementos constituintes de diferentes tipos de composições e produtos, tornando-os diferentes dos equivalentes descritos no estado da técnica.

Classic genetic selection methods or even genome modification techniques can also be used to exacerbate the production of the elements of interest, obtaining a greater yield of the extract or even a more intense flavouring and aromatising effect.

In this scenario, we demonstrate that vanillas from the Atlantic Forest, namely Vanilla bahiana, Vanilla cribbiana and V. chamissonis, produce important bioeconomic compounds. The three species evaluated here have the potential to meet the demand for diversification within the vanilla commercial scenario. The phenotypic characteristics described here through an untargeted metabolomics approach are of valuable flavour molecules or otherwise of biotechnological importance. The idea of introducing new species of vanilla as varieties of the condiment to be enjoyed by general consumers in the broad spectrum of this sensory experience could take them to the same baseline as wine or coffee cultures, in which varieties, mixtures and combinations are a important part of culture and market. Consequently, it could also alleviate commercial pressure on the most traded species, V. planifolia. Furthermore, the use of vanilla species from the Atlantic Forest could benefit agroforestry programs that would improve the income of producers in local communities through sustainable cultivation.

Therefore, the present invention provides for the use of extracts from orchids of the species V. chamissonis, V. cribbiana and V. bahiana for the manufacture of flavouring and/or perfuming agents, among other advantages, similar or alternative to vanilla according to the metabolic matrix observed in its fruits compared to the fruits of V. planifolia.

### Sensory Experiments (Consumer Acceptance and Evaluation of Sensory Characteristics):

All sensory tests were carried out at the Sensory and Consumer Sciences Laboratory (LASEN) of the Federal University of the State of Rio de Janeiro (UNIRIO), using individual sensory cabins designed in accordance with ISO 8589 (ISO, 2007), under controlled temperature (22° C.) and artificial daylight.

Ripe fruits (pods, beans, etc.) were collected from the Brazilian Atlantic Forest, with due authorization from the competent bodies, and then stored at −80° C. until the time of testing, encompassing the following species: V. bahiana—RB01111540, V. cribbiana—HUNI 6715, V. chamissonis—HUNI 4402, and V. planifolia—RB 777274.

For this sensory test, the fruits were subjected to an enzymatic treatment according to the protocol by Ruiz-Terán et al. (2001) and adapted by Silva Oliveira, Garrett, Koblitz, et al. (2022) [Ruiz-Terán, F., Perez-Amador, I., & López-Munguia, A. (2001). Enzymatic extraction and transformation of glucovanillin to vanillin from vanilla green pods. Journal of Agricultural and Food Chemistry, 49(11), 5207-5209. https://doi.org/10.1021/jf010723h; da Silva Oliveira, J. P., Garrett, R., Koblitz, M. G. B., & Macedo, A. F. (2022). Vanilla flavour: Species from the Atlantic forest as natural alternatives. Food Chemistry, 375, 131891 https://doi.org/10.1016/J.FOODCHEM.2021.131891].

For this extraction, used for sensory testing purposes, five milliliters of grain alcohol (92.8%) were added to the dried samples (500 mg) and shaken. Subsequently, each sample was subjected to ultrasound extraction (QR500 Ultronique Indaiatuba Brasil) for 8 min at 80% power and centrifuged for 10 min at 10,000×g at 4° C. (Megafuge 16R—Langenselbold, Germany).

The supernatant was transferred to a 5 mL volumetric flask and the volume was completed with pure grain alcohol. For use, extracts were diluted to 40% grain alcohol with ultrapure water (Milli-Q® Direct 8/16 System—Molsheim, France).

According to Hariom et al. [Hariom, Shyamala, B., Prakash, M., & Bhat, K. (2006). Vanilla flavour evaluation by sensory and eletronic nose techniques], milk is considered an ideal vehicle for perceiving the characteristics of vanilla. The vanilla extracts obtained above and a commercial artificial vanilla essence were added to 1% fat, lactose-free UHT milk. Commercial artificial vanilla essence and UHT milk may be those available on the market. The extracts or essence were added to refrigerated milk (at 8° C.±3° C.), in 250 mL cups, stirred manually for 15 seconds and stored under refrigeration (8° C.±3° C.) until use. Samples (20 mL at 8±3° C.) were served to 250 participants (groups of 50 individuals) in disposable plastic cups with lids (75 mL), coded with three-digit numbers.

Consumers performed five pairwise comparison tests for each vanilla. Each pairwise comparison was comprised of a control sample (vanilla-free milk) and a vanilla-flavoured milk sample with one specific vanilla at a time (extract or essence). Table 4 below shows the concentration of vanilla (extract and essence) added to the milk in each test.

TABLE 4
Percentage (%) of vanilla extract or essence per
test to estimate the difference threshold.

| Vanilla extract or | | | | | |
|---|---|---|---|---|---|
| essence | Test 1 | Test 2 | Test 3 | Test 4 | Test 5 |
| Vanilla Essence | 0.005* | 0.0075 | 0.01 | 0.0125 | 0.015 |
| V. planifolia | 0.04* | 0.06 | 0.08 | 0.10 | 0.12 |
| V. cribbiana | 0.01* | 0.02 | 0.04 | 0.06 | 0.08 |
| V. chamissonis | 0.005* | 0.01 | 0.02 | 0.04 | 0.06 |
| V. bahiana | 0.04* | 0.06 | 0.08 | 0.10 | 0.12 |

*Initial concentration

Participants were instructed to flavour both samples, control (pure milk) and test (vanilla flavoured milk), from left to right and instructed to select the one they considered to contain vanilla flavour, assigning the corresponding number on the evaluation sheet. The samples in each pair were presented following a balanced design [Macfie, H. J., & Bratchell, N. (1989). Designs to balance the effect of order of presentation. 4, 129-148]. Consumers were also instructed to clean their palate with mineral water at room temperature and ingest a cookie after tasting each sample.

The difference limits (threshold) were estimated using survival analysis (Table 4), adapted from the methodology proposed by Hough et al. (2003), which recognizes the existence of censored data [Hough, G., Langohr, K., Gómez, G., & Curia, A. (2003). Survival analysis applied to sensory shelf life of foods. Journal of Food Science, 68(1), 359-362].

TABLE 5
Difference thresholds (difference threshold) for the addition
of vanilla to milk in relation to the control in five studies.

| | Threshold difference | |
|---|---|---|
| Vanilla | expressed as the | |
| essence or | concentration of vanilla | 95% confidence |
| extract | added (%) | interval |
| Vanilla essence | 0.0015 | 0.0009-0.0024 |
| V. planifolia | 0.0800 | 0.0600-0.1100 |
| V. cribbiana | 0.0300 | 0.0100-0.1500 |
| V. chamissonis | 0.0500 | 0.0100-0.1600 |
| V. bahiana | 0.0600 | 0.0300-0.1200 |

After determining the difference thresholds for each vanilla sample (extracts and essence) in milk, a study was carried out to evaluate the sensorial and hedonic perception of the samples with the participation of 121 consumers, as recommended in Hough et al. (2003).

Six samples were evaluated, one being a control sample (milk without vanilla) and another five milks with vanilla flavour, due to the addition of the following vanillas (concentrations): V. planifolia (0.160%). V. bahiana (0.120%). V. chamissonis (0.100%). V. cribbiana (0.060%) and vanilla essence (0.003%). respectively.

TABLE 6
Overall mean acceptance score (liking ^{§} scores) for vanilla-flavoured
milk for all consumers (n = 121) and for the two consumer
segments identified in the group analysis (Clusters).

| | General | | |
|---|---|---|---|
| | Acceptance | Cluster 1 | Cluster 2 |
| Sample | (n = 121) | (n = 54) | (n = 67) |
| Vanilla Essence | 6.8 ± 1.41 ^{a} | 6.9 ± 1.30 ^{aA} | 6.8 ± 1.50 ^{aA} |
| V. planifolia | 6.4 ± 1.68 ^{ab} | 5.9 ± 1.70 ^{bcB} | 6.8 ± 1.57 ^{aA} |
| V. cribbiana | 6.3 ± 1.55 ^{bc} | 6.1 ± 1.69 ^{bcB} | 6.5 ± 1.41 ^{aA} |
| V. chamissonis | 6.1 ± 1.52 ^{bcd} | 5.6 ± 1.60 ^{cB} | 6.5 ± 1.32 ^{aA} |
| V. bahiana | 5.7 ± 1.85 ^{d} | 4.5 ± 1.37 ^{dB} | 6.7 ± 1.57 ^{aA} |
| Controle | 5.9 ± 1.58 ^{cd} | 6.3 ± 1.33 ^{abA} | 5.6 ± 1.71 ^{bB} |

^{§} Evaluated on 9-point hedonic scales. Mean values with the same lowercase letters within the same column do not differ significantly (p > 0.05) according to the Tukey test. The mean values with the same capital letters within the same line do not differ significantly (p > 0.05), according to the t test.

The general average of the acceptance results (Liking scores) of the six samples ranged from 5.7±1.85 (V. bahiana) to 6.8±1.41 (artificial essence), as can be seen in the Table 6. Species significantly affected consumer acceptance (p≤0.05). The samples with the greatest acceptance (n=121) were vanilla essence and V. planifolia. V. cribbiana achieved good acceptance rates, not differing from V. planifolia (commonly used). V. cribbiana and V. chamissonis (native vanillas) were accepted similarly to the commercial sample. This is quite interesting because they are in lower concentration compared to the sample that contains commercial vanilla extract (V. planifolia).

Participants tasted the samples and marked their degree of general acceptance on a 9-point hedonic scale, ranging from ‘disliked very much’ (score=1) to ‘liked very much’ (score=9) and then passed to describe the sensory characteristics of the samples using a “Rate-All-that-Apply” (RATA) questionnaire, composed of 11 previously defined sensory attributes (aroma and flavour) [Peryam, D. R., & Pilgrim, F. J. (1957). Hedonic scale method of measuring food preference. Food Technology, 11, 9-14], they were asked to describe the sensory characteristics of the samples using a “Rate-All-That-Apply” (RATA) questionnaire, composed of 11 sensory attributes, previously defined according to the literature [Cadena, R. S., Cruz, A. G., Faria, J. A. F., & Bolini, H. M. A. (2012). Reduced fat and sugar vanilla ice creams: Sensory profiling and external preference mapping. Journal of Dairy Science, 95(9), 4842-4850. https://doi.org/10.3168/jds.2012-526; Dooley, L., Lee, Y. seung, & Meullenet, J. F. (2010). The application of check-all-that-apply (CATA) consumer profiling to preference mapping of vanilla ice cream and its comparison to classical external preference mapping. Food Quality and Preference, 21(4), 394-401. https://doi.org/10.1016/j.foodqual.2009.10.002; Liu, Y., Toro-Gipson, R. S. D., & Drake, M. A. (2021). Sensory properties and consumer acceptance of ready-to-drink vanilla protein beverages. Journal of Sensory Studies, 36(6). https://doi.org/10.1111/joss.12704]. In a preliminary session, using previous studies (Cadena et al., 2012; Dooley et al., 2010; Liu et al., 2021) and with the participation of 10 evaluators, the attributes that would make up the terms of the questionnaire were selected: sweet aroma, milk aroma, vanilla aroma, alcoholic aroma, bitter flavour, bush flavour, fermented flavour, vanilla flavour, sweet flavour, milk flavour, and alcoholic flavour.

Consumers rated the intensity of perceived terms using a structured 3-point scale (1: “low”, 2: “medium”, and 3: “high”), as shown in Table 7.

TABLE 7
Mean scores (and standard deviations) of terms from the Rate-All-That-Apply
(RATA) questionnaire to describe the sensory characteristics of the samples.

| | Samples | | | | | |
|---|---|---|---|---|---|---|
| | Vanilla | V. | V. | V. | V. | |
| Attributes | Essence | planifolia | cribbiana | chamissonis | bahiana | Control^{§} |
| Sweet aroma | 1.17 | 1.07 | 0.80 | 0.78 | 0.73 | 0.81 |
| | (±1.09)^{a} | (±1.09)^{a} | (±0.99)^{b} | (±0.95)^{b} | (±0.94)^{b} | (±0.98)^{b} |
| Milk aroma | 1.77 | 1.31 | 1.66 | 1.70 | 1.61 | 2.09 |
| | (±1.04)^{b} | (±1.04)^{c} | (±1.10)^{b} | (±1.07)^{b} | (±1.12)^{b} | (±0.97)^{a} |
| Vanilla aroma | 1.13 | 1.37 | 0.94 | 0.78 | 0.80 | 0.38 |
| | (±1.11)^{b} | (±1.15)^{a} | (±1.02)^{bc} | (±0.98)^{c} | (±0.99)^{c} | (±0.75)^{d} |
| Alcoholic | 0.04 | 0.26 | 0.12 | 0.14 | 0.28 | 0.03 |
| aroma | (±0.24)^{bc} | (±0.60)^{a} | (±0.43)^{bc} | (±0.44)^{b} | (±0.69)^{a} | (±0.16)^{c} |
| Bitter flavour | 0.06 | 0.13 | 0.18 | 0.15 | 0.29 | 0.08 |
| | (±0.24)^{c} | (±0.41)^{bc} | (±0.53)^{b} | (±0.44)^{bc} | (±0.63)^{a} | (±0.33)^{bc} |
| Bush | 0.06 | 0.06 | 0.06 | 0.06 | 0.06 | 0.06 |
| flavour^{NS} | (±0.29)^{a} | (±0.29)^{a} | (±0.29)^{a} | (±0.29)^{a} | (±0.29)^{a} | (±0.29)^{a} |
| Fermented | 0.19 | 0.19 | 0.19 | 0.19 | 0.19 | 0.19 |
| flavour^{NS} | (±0.54)^{a} | (±0.53)^{a} | (±0.54^{)a} | (±0.54)^{a} | (±0.53)^{a} | (±0.53)^{a} |
| Vanilla flavour | 1.67 | 1.71 | 1.35 | 1.14 | 0.97 | 0.48 |
| | (±1.11)^{a} | (±1.06)^{a} | (±0.99)^{b} | (±1.04)^{bc} | (±0.95)^{c} | (±0.76)^{d} |
| Sweet flavour | 1.30 | 1.28 | 1.14 | 1.18 | 0.95 | 0.94 |
| | (±1.04)^{a} | (±1.08)^{a} | (±1.04)^{ab} | (±1.06)^{a} | (±0.96)^{b} | (±0.95)^{b} |
| Milk flavour | 1.83 | 1.41 | 1.77 | 1.73 | 1.72 | 2.32 |
| | (±1.18)^{b} | (±1.11)^{c} | (±1.04)^{b} | (±1.07)^{b} | (±1.10)^{b} | (±0.90)^{a} |
| Alcoholic | 0.05 | 0.14 | 0.08 | 0.13 | 0.20 | 0.03 |
| flavour | (±0.31)^{cd} | (±0.45)^{ab} | (±0.37)^{bcd} | (±0.40)^{abc} | (±0.57)^{a} | (±0.18)^{d} |

^{§}Control: Leite semidesnatado com gordura 1% livre de lactose.
* Means with the same lowercase letters in the same row are not significantly different (p > 0.05) by Fisher's test.
^{NS}not significant.

Consumers detected/perceived differences in the sensory characteristics of different species of vanilla. The sweet aroma and vanilla flavour did not differ between V. planifolia and essence, with the greatest intensity of vanilla aroma being observed for these two samples. The milk added with vanilla essence and extracts resulted in a reduction in the aroma and flavour attributes of the milk, typical of the control. Vanilla flavour and aroma had a higher average score for V. planifolia; however, the vanilla flavour score did not differ from the commercial essence. The vanilla aroma of V. cribbiana did not differ statistically in relation to the vanilla essence. Furthermore, it achieved good intensity scores in terms of flavour. The average “vanilla” flavour was lower than the control, which differed from all samples. The intensity of the following attributes: alcoholic aroma, bitter flavour, and alcoholic flavour, were considered low by the participants. The average sweet flavour score increased in vanilla samples compared to the control, except in V. bahiana. Thus, the control sample was separated from the others and was described as having a milky flavour and aroma, V. bahiana had a bitter flavour, a fermented and alcoholic flavour and an alcoholic aroma. V. planifolia, as well as the artificial essence tended to be considered sweeter in both aroma and taste and higher in vanilla aroma and flavour.

This result, in itself surprising, places vanilla species native to Brazil at the same level as international and commercial species, indicating that there is a similar concentration range in all extracts (native or commercial), which causes a change in consumers' perception of the vanilla flavour. Furthermore, when comparing only the average concentrations found as a difference threshold, the commercial species was the one with the highest concentration, indicating that a greater amount of V. planifolia extract is necessary to be perceived as vanilla flavour when compared to the other species tested (V. bahiana>V. chamissonis>V. cribbiana). No significant difference was found in the general mean of liking scores between V. planifolia, V. cribbiana and V. chamissonis.

In addition to evaluating general acceptance, a sensory characterization was also carried out with RATA. In the present study, acceptance and RATA evaluation contributed to the understanding of the characteristics of the samples, revealing the acceptance factors (liking scores), which can help the selection of species with the potential to be used commercially in the production of vanilla extract. The control sample was separated from the others and was described as having both the flavour and aroma of milk, which was expected as there was no vanilla extract or essence added. V. bahiana had a bitter, fermented, alcoholic flavour and alcoholic aroma, with fewer characteristic vanilla attributes. The control sample was separated from the others and was described as having both the flavour and aroma of milk, which was expected as there was no vanilla extract or essence added. V. bahiana had a bitter, fermented, alcoholic flavour and alcoholic aroma, with fewer characteristic vanilla attributes. It is worth commenting that V. planifolia extract is commercially used to produce natural vanilla flavour, is known to produce highly aromatic vanilla fruits (Leyva et al., 2021), and is considered the species which provides the best quality extract for food preparations [Homma, A. K. O., de Menezes, A. J. E. A., & de Matos, G. B. (2006). Cultivo de Baunilha: uma Alternativa para a Agricultura Familiar na Amazônia. www.cpatu.embrapa.br]. According to the PCA, V. cribbiana and V. chamissonis are similar and were not far from V. planifolia.

Although V. bahiana presented a more differentiated potential for commercialization according to the sensory profile described, the fact that V. cribbiana and V. chamissonis do not present a significant difference in acceptance in relation to the commercial sample and the fact that they are also described in a similar way, suggests that these native Brazilian species of Vanilla sp. They have a vanilla flavour with potential for success in the Brazilian market and may be the best for potential commercial exploitation in food products. Furthermore, they are potential sources of genetic material for crossbreeding, in order to obtain more resistant commercial varieties adapted to the climatic conditions of the Atlantic Forest, without reducing the flavour produced by the fruit. Finally, the cultivation of native species can be presented to gourmet consumers as new sources of vanilla flavour. And, the cultivation of native vanilla species can benefit the areas where they are grown, bringing economic development to the population, and helping to maintain forest areas.

### EXAMPLES

### Example 1: Ethanolic Extraction Method

To carry out the present invention, one form of extraction is ethanolic.

Vanilla capsules, pods, beans, grains and/or fruits intended for metabolome analysis were collected and immediately frozen in liquid N₂. Subsequently, the plant material was freeze-dried. For extraction, a previously described method was used [Andrews Zhizhe Dong, Fenglin Gu, Fei Xu, Qinghuang Wang (2014). Comparison of four kinds of extraction techniques and kinetics of microwave-assisted extraction of vanillin from Vanilla planifolia. Food Chemistry, Volume 149, 15 Apr. 2014, Pages 54-61], with possible modifications and adjustments. About 4 g of powdered vanilla capsules were mixed with 100 mL of ethanol-water (70%) and then heated using a microwave device (250 W) for 18 min.

The vanilla extract was dried, desalinized and filtered through a 25 mm PTFE 0.45 μm syringe filter, before injection through the ACQUITY UPLC I-Class instrument coupled to a model Q-TOF mass spectrometer Xevo G2-S QTof (Waters, Manchester, UK). Each extract was evaluated in triplicate. When necessary, hydrolysis of glycosides was carried out, incubating the extract with Viscozyme and Celluclast at 45° C./8 hours (Maruenda et al., 2013).

### Example 2: Methanolic Extraction Method

in a non-limiting way, we present one of the methods that can be used to obtain the extract from the orchids targeted by this invention. Methanolic extraction (MeOH) proved to be one of the most effective in quantitative and qualitative terms, as it presented the highest average intensity of identified metabolites and, therefore, will be the preferred extraction methodology in this invention, however other forms of extraction can be used or even developed.

### Example 3: Extraction Method with Enzymatic Curing

Ripe fruits of each species were collected and macerated in liquid nitrogen (N₂) until they formed a fine, clear powder. Enzymatic treatment (ET) (biochemical cure) followed an adapted protocol based on the cited publications (Ranadive, 1992; Francisco Ruiz-Terán, Perez-Amador, & López-Munguia, 2001). The macerated powder was diluted and vortexed by mixing 0.05 M citrate-phosphate buffer pH 5, which was prepared with citric acid (0.1 M) and dibasic sodium phosphate (0.2 M). The β-glucosidase enzyme (1 mg mL⁻¹) was prepared with the same buffer and 1 mL of the stock solution was added to each sample. The mixture was subjected to incubation in a water bath at 37° C. for a period of 4 h. After incubation, the samples were stored in a freezer at −80° C. After thawing, the citrate-phosphate buffer was dried with a vacuum centrifuge.

Subsequently, methanolic extraction (MeOH) was carried out with the samples that were subjected to TE and those that were not. Methanol was added to each sample, then vortex mixed and subjected to ultrasound-assisted extraction (UAE) with an ultrasonic probe (DESRUPTOR 500W, Ultronique). This procedure was repeated three times in total and each time the supernatant was collected and reserved. The solvent was evaporated in a vacuum centrifuge (Savant, Thermo Scientific). The dried extracts were then diluted in methanol, acetonitrile, and Milli-Q water.

### Example 4: Food Composition—Sweetener

Due to the possibility of using natural and synthetic sweeteners, the present invention can generate food products with a reduced glycemic index by replacing part of the conventional sugar without loss of sweetening power. The sweetener proposed here can be added with natural plant extracts, such as ginger, cinnamon, lemon, pomegranate, acerola, passion fruit, but not limited to these.

In this proposal for additives with natural extracts, the sweeteners now have the intrinsic pharmacological functionality of each extract, in addition to giving the sweetener flavour notes of the extract in particular, thus enhancing the qualities of dark sugars in natural pharmacological activities.

The example above was described to illustrate one of the ways of applying VC, VCB and VB extracts in food production, in this case, sweetener. Its final composition can be defined depending on the different types of raw materials and additives, and should not be seen as limiting this invention, knowing that small variations from what was described above will still be part of the scope of this invention.

In this sense, we use the example of a sweetener to demonstrate that the scope of the present invention also covers the different uses and applications of Vanilla extract compositions of the present invention (VC, VCB and VB), which, as they have a different metabolome from those of orchids previously known and used in industry can be used to promote different/improved flavours, aromas and properties. The main, however, non-limiting applications are: pharmaceutical industry, cosmetic industry, food industry and tabletop use in general.

To adapt the compositions to each of their applications in each type of industry, other elements can be added to the final composition as well as other forms of extraction methods, known to those skilled in the art.

Therefore, in addition to the above examples, conventional extraction processes can be used to carry out the invention, such as, but without limitation, supercritical fluid extraction, in particular, with CO₂ as supercritical fluid, soxhlet extraction and extraction assisted by ultrasound using different solvents and different operating temperatures. Typically, ethanol, methanol, acetonitrile, acetone, chloroform and hexane were used in the ranges of 90 to 100° C. [Jadhav et al., Extraction of vanilina from vanilla pods: A comparison study of conventional soxhlet and ultrasound assisted extraction, Journal of Food Engineering, volume 93, emitido em 4 de agosto de 2009, páginas 421 a 426].

The agents or compositions of the present invention may also additionally comprise one or more “coingredients”. By “coingredient” is meant a compound that is used in aromatising or perfuming preparations or compositions to impart a hedonic effect. In other words, such an ingredient, to be considered a aromatising or perfuming agent, must be recognized by a person skilled in the art as capable of transmitting or modifying in a positive or pleasant way the taste or odor of a composition and not just because it has a taste or odor.

The nature and type of aromatising or perfuming co-ingredients present in the composition do not guarantee a more detailed description in this document, and the knowledgeable element has the ability to select them based on their general knowledge and according to the use or application desired and the desired organoleptic effect. In general terms, these aromatising or perfuming co-ingredients belong to chemical classes as varied as alcohols, aldehydes, ketones, esters, ethers, acetates, nitriles, terpenoids, nitrogenous or sulfurous heterocyclic compounds and essential oils and in which said aromatising or perfuming co-ingredients can be of natural or synthetic origin.

Many of these coingredients are, in any case, listed in reference texts, such as the book by S. Arctander, Perfume and Flavour Chemicals, 1969, Montclair, New Jersey, USA, or its most recent versions, or, in other words, of a similar nature, as well as in the abundant patent literature in the field of aroma and perfumery. It is also understood that said co-ingredients may also be compounds known to release in a controlled manner various types of aromatising or perfuming compounds.

A non-limiting list of suitable aromatising coingredients that could be used includes phenol, 2-methoxyphenol, 2-methoxy-4-vinyl-phenol, 4-methyl-phenol, 2-methoxy-4-(2-propen-1-yl)phenol, 2-methoxy-4-(1-propen-1-yl)phenol, 2-methoxy-4-methylphenol, 2,6-dimethoxy-phenol, 2-ethoxy-5-(1-propenyl)phenol, 4-ethenylphenol, 2-methyl-phenol, 4-hydroxy-benzenemethanol, (4-methoxyphenyl)methyl formate, 4-methoxybenzaldehyde, 3-ethoxy-4-hydroxybenzaldehyde, benzaldehyde, 3,4-dimethoxy-benzaldehyde, 4-methoxybenzoic acid, 1,3-benzodioxol-5-carbaldehyde, 4-methoxy-benzenemethanol, 3-hydroxy-2-methyl-4H-pyran-4-one, 4-(4-methoxyphenyl)-2-butanone, 4-methoxybenzyl acetate, 4-hydroxy-2,5-dimethyl-3-furanone, 4-methoxy-benzenemethanol acetate, ethyl 3-phenyl-2-propenoate, 3-phenyl-2-methylropenoate, ethyl benzoate, 1,4-dimethoxybenzene, 2-ethyl-3-hydroxy-4H-pyran-4-one, 3-phenyl-2-propenal, phenylacetaldehyde, 5,6-dihydro-6-pentyl-2H-pyran-2-one, decanoic acid, butanoic acid; 2-methylpropanoic acid, dihydro-5-pentyl-2(3H)-furanone, methyl 2-hydroxybenzoate, methyl 2-hydroxybenzoate, 6-methyl-2H-1-benzopyran-2-one, 3,4-dihydro-2H-1-benzopyran-2-one, 1-enzopyran-2-one, hexahydro-3,6-dimethyl-2(3H)-benzofuranone, tetrahydro-6-propyl-2H-pyran-2-one, 6-butyltetrahydro-2H-pyran-2-one, 6-heptyltetrahydro-2H-pyran-2-one, 3-fenil-2-propen-1-ol, 2-furanmetanol, 3-phenyl-2-propenoic acid, 2-furancarboxaldehyde, 3-hydroxy-2-butanone, 2,3-pentanedione, 2-hydroxybenzaldehyde, 5-pentylfuran-2(5H)-one, 2-hydroxy-4-methoxybenzoate methyl, 5-allyl-1,2,3-trimethoxybenzene, (−)-(1R,4E,9S)-4,11,11-trimethyl-8-methylenebicyclo[7.2.0]undec-4-ene, tetrahydro-6-pentyl-2H-pyran-2-one, 3-methylbutanal, 1-(2-hydroxy-4-methoxyphenyl) ethanone, cocoa extract, vanilla extract, benzoin extract, balsam of Peru extract, tolu extract, guaiac wood oil and a combination thereof.

Preferably, the aromatising coingredient can be selected from the group consisting of phenol, 2-methoxyphenol, 2-methoxy-4-vinyl-phenol, 4-methyl-phenol, 2-methoxy-4-(2-propen-1-yl)phenol, 2-methoxy-4-(1-propen-1-yl)phenol, 2-methoxy-4-methyl-phenol, 2,6-dimethoxy-phenol, 2-ethoxy-5-(1-propenyl)phenol, 4-ethenylphenol, 2-methyl-phenol, 4-hydroxybenzenemethanol, (4-methoxyphenyl)methyl formate, 4-methoxybenzaldehyde, 3-ethoxy-4-hydroxybenzaldehyde, benzaldehyde, 3,4-dimethoxy-benzaldehyde, 4-methoxy-benzoic acid, 1,3-benzodioxol-5-carbaldehyde, 4-methoxy-benzenemethanol, 3-hydroxy-2-methyl-4H-pyran-4-one, 4-(4-methoxyphenyl)-2-butanone, 4-methoxybenzyl acetate, 4-hydroxy-2,5-dimethyl-3-furanone, 4-methoxy-benzenemethanol acetate, 3-phenyl-2-propenyl-ol, 2-furanmethanol, 3-phenyl-2-propenoic acid, 2-furancarboxaldehyde, 3-hydroxy-2-butanone, 2,3-pentanedione, Tetrahydro-6-pentyl-2H-pyran-2-one, 3-methyl-butanal, 1-(2-hydroxy-4-methoxyphenyl)ethanone, cocoa extract, vanilla extract, benzoin extract, Peruvian balsam extract, tolu extract, guaiacwood oil and a combination thereof. Even more preferably, the aromatising coingredient may be selected from the group consisting of phenol, 2-methoxyphenol, 2-methoxy-4-vinyl-phenol, 2-methoxy-4-(2-propen-1-yl)phenol, 2-methoxy-4-(1-propen-1-yl)phenol, 2-metoxi-4-(1-propen-1-il)fenol, 2-metoxi-4-metil-fenol, 2-etoxi-5-(1-propenil)fenol, 4-ethenylphenol, 4-methoxybenzaldehyde, benzaldehyde, 4-methoxybenzoic acid, 1,3-benzodioxol-5-carbaldehyde, 3-hydroxy-2-methyl-4H-pyran-4-one, 4-hydroxy-2,5-dimethyl-3-furanone, 1-(2-hydroxy-4-methoxyphenyl)ethanone and a combination thereof.

The concentrations (in ppm RTC) of these compounds are: phenol (0.0001 to 0.3); 2-methoxyphenol (0.0001 to 0.5); 2-methoxy-4-vinyl-phenol (0.0001 to 0.3); 2-methoxy-4-(2-propen-1-yl)phenol; 2-methoxy-4-(1-propen-1-yl)phenol (0.0001 to 0.1); 2-methoxy-4-methyl-phenol (0.0001 to 0.5); 2-ethoxy-5-(1-propenyl)phenol (0.0001 to 5); 4-ethenylphenol (0.0001 to 0.3); 4-methoxy benzaldehyde (0.0005 to 5); benzaldehyde (0.0001 to 5); 4-methoxy-benzoic acid (0.1 to 200); 1,3-benzodioxol-5-carbaldehyde (0.01 to 50); 3-hydroxy-2-methyl-4H-pyran-4-one (0.05 to 200), 4-hydroxy-2,5-dimethyl-3-furanone (0.05 to 100).

According to any of the above embodiments, the composition of the invention may comprise one or more vanilla enhancers. The term “vanilla enhancer” designates any compounds that have a positive impact on the vanilla aroma, in particular, compounds that make it possible to intensify, enhance or modify the odor properties of a vanilla aroma composition. Examples of suitable vanilla enhancer include, but are not limited to, 2-methyl-propanal, 1-pentanol, hexanal, 2-methyl-butanoic acid, 3-methyl-butanoic acid, 5-methyl-2-furancarboxaldehyde, heptanal, 1-octen-3-one, 1-octen-3-ol, octanal, 3-hydroxy-4,5-dimethyl-2(5H)-furanone, benzenothanol, 2,6-nonadienal, E-2-nonenal, 2-decanone, 2,4-decadienal, 2-methoxy-4-(methoxymethyl)phenol, (2E)-1-(2,6,6-trimethyl-1,3-cyclohexadien-1-yl)-2-buten-1-one, 2-methyl-butanal, 3-methyl-3-buten-2-one, pentanal, ethyl propanoate, 1,1-diethoxyethane, ethyl 2-methylpropanoate, dihydro-2(3H)-furanone, hexanoic acid, 2-heptanone, 3-heptanone, 2-heptenal, ethyl hexanoate, methyl heptanoate, ethyl 4-oxopentanoate, 1-(2-pyrrolyl)-1-ethanone, 1-octanol, 2-decenal, 3-decenal, 4-decenal, 4-(methoxymethyl)phenol, ethyl nonanoate, methyl 2-aminobenzoate, ethyl 2-aminobenzoate, methyl 2-(methylamino)benzoate, 5-hexyldihydro-2(3H)-furanone, 5-ethyldihydro-2(3H)-furanone, 5-butyldihydro-2(3H)-furanone, 6-hexyltetrahydro-2H-pyran-2-one, 5-heptyldihydro-2(3H)-furanone, 5-octyldihydro-2(3H)-furanone, 5-methyl-2(3H)-furanone, 5-propyldihydro-2(3H)-furanone, 6-methyltetrahydro-2H-pyran-2-one, decenoic acid, 5-methyldihydro-2(3H)-furanone, 5-butyldihydro-4-methyl-2(3H)-furanone, ethyl 3-phenylpropanoate, 4-hydroxybenzaldehyde, methyl 4-methoxybenzoate, 3-hydroxy-4-methoxybenzaldehyde, 4-hydroxy-3-methoxybenzyl alcohol, 4-(ethoxymethyl)-2-methoxyphenol, 4-hydroxybenzoic acid, 4-hydroxy-3-methoxybenzoate methyl, ethyl 4-hydroxy-3-methoxybenzoate, ethyl 4-hydroxybenzoate, 4-hydroxy-3-methoxybenzoic acid, dodecanoic acid, 4-hydroxy-3,5-dimethoxybenzaldehyd, (E)-3-(4-hydroxy-3-methoxy-1-phenyl)-2-propenal, tetradecanoic acid, ethyl tetradecanoate, hexadecanoic acid, octadecanoic acid, (Z)-9-octadecenoic acid, ethyl prop-2-enoate, ethyl butanoate, ethyl but-2-enoate, ethyl 2-methylbutanoate, 2-methylbutanoic acid, 1-hexanol, 1-phenyl ethanone, methyl benzoate, ethyl heptanoate, ethyl octanoate, 1,2-dimethoxy-4-methylbenzene, ethyl dodecanoate, Ethyl 4-methoxybenzoate, (3E)-4-(2,6,6-trimethyl-1-cyclohexen-1-yl)-3-buten-2-one, (E)-2-butenal or (E)-1-(4-methoxy-1-phenyl)-1-penten-3-one.

According to any of the above embodiments, the composition of the invention may comprise at least one aroma or perfume carrier. The term “aroma or perfume carrier” designates a material that is substantially neutral from an aroma or perfume point of view, provided that this does not significantly alter the organoleptic properties of aromatising ingredients or perfuming ingredients. The carrier can be a liquid or a solid.

Liquid carriers include, for example, an emulsifying system, that is, a solvent and a surfactant system, or a solvent commonly used in aromas or perfumery. A detailed description of the nature and type of solvents commonly used in aromas or perfumery cannot be exhaustive. Suitable solvents used in flavouring include, for example, propylene glycol, triacetin, caprylic/capric triglyceride (neobee®), triethyl citrate, benzyl alcohol, ethanol, vegetable oils such as linseed oil, sunflower oil or coconut oil, glycerol.

One can cite as non-limiting examples of perfume solvents, solvents such as butylene or propylene glycol, glycerol, dipropylene glycol and its monoether, 1,2,3-propanetriyl triacetate, dimethyl glutarate, dimethyl adipate acetate 1,3-diacetyloxypropan-2-yl, diethyl phthalate, isopropyl myristate, benzyl benzoate, benzyl alcohol, 2-(2-ethoxyethoxy)-1-ethane, triethyl citrate, ethanol, water/water mixtures ethanol, limonene or other terpenes, isoparaffins such as those known under the trade name Isopar® (origin: Exxon Chemical) or glycol ethers and glycol ether esters such as those known under the trademark Dowanol® (origin: Dow Chemical Company), or hydrogenated castor oils, such as those known under the trade name Cremophor® RH 40 (origin: BASF) or mixtures thereof.

Suitable solid carriers include, for example, absorbent polymers or gums, or even encapsulating materials. Examples of such materials may comprise wall-forming materials and plasticizers, such as mono-, di- or polysaccharides, natural or modified starches, hydrocolloids, cellulose derivatives, polyvinyl acetates, polyvinyl alcohols, xanthan gum, gum arabic, gum acacia or materials cited in reference texts such as H. Scherz, Hydrokolloid: Stabilisatoren, Dickungs-und Geliermittel in Lebensmitteln, Band 2 der Schriftenreihe Lebensmittelchemie, Lebensmittelqualität, Behr's VerlagGmbH & Co., Hamburg, 1996. Encapsulation is a process well known to one skilled in the art, and can be carried out, for example, using techniques such as spray drying, agglomeration, extrusion, coating, plating, coacervation and the like.

The composition of the invention may comprise at least one aroma adjuvant. By “aroma adjuvant”, here is meant an ingredient with the ability to impart additional added benefits such as a color (e.g., caramel), chemical stability, and so on. A detailed description of the nature and type of adjuvant commonly used in aromatising compositions cannot be exhaustive. However, such adjuvants are known to a person skilled in the art who may select them based on his general knowledge and in accordance with the intended use or application. The following may be cited as specific non-limiting examples: viscosity agents (e.g. emulsifier, thickening agents, gelling and/or rheology modifiers, e.g. pectin or agar gum), stabilizing agents (e.g. antioxidant, heat/light and or buffering agents, e.g., citric acid), coloring agents (e.g., natural or synthetic or natural extract that imparts color), preservatives (e.g., anti-antibacterial, antimicrobial or antifungal agents, e.g., benzoic acid), vitamins and mixtures thereof.

The composition of the invention may comprise at least one perfuming adjuvant. By “perfuming adjuvant” is meant here an ingredient capable of imparting additional added benefit, such as a color, particular light resistance, chemical stability, etc. A detailed description of the nature and type of adjuvant commonly used in perfume compositions cannot be exhaustive, but it must be mentioned that said ingredients are well known to a person skilled in the art. The following may be cited as specific non-limiting examples: viscosity agents (e.g. surfactants, thickeners, gelling and/or rheology modifiers), stabilizing agents (e.g. preservatives, antioxidants, heat/light agents and/or buffers or chelators, such as BHT), coloring agents (e.g., dyes and/or pigments), preservatives (e.g., antibacterial or antimicrobial or antifungal or antiirritant agents), abrasives, skin cooling agents, fixatives, insect repellents, ointments, vitamins and mixtures thereof.

According to any of the above embodiments, the composition of the invention may comprise sweeteners. Non-limiting examples of suitable sweeteners include common saccharide sweeteners, e.g. sucrose, fructose (e.g. D-fructose), glucose (e.g. D-glucose); sweetener compositions comprising natural sugars, such as stevia (all types and grades), corn syrup (including high fructose corn syrup) or other syrup concentrates or sweetener derived from natural fruit and vegetable sources; semi-synthetic “sugar alcohol” sweeteners, such as erythritol, isomalt, lactitol, mannitol, sorbitol, xylitol, maltodextrin, glycerol, threitol, arabitol, ribitol and dulcitol; artificial sweeteners such as miraculin, aspartame, superaspartame, saccharin, saccharin sodium salt, acesulfame-K, cyclamate, sodium cyclamate and alitame; other sweeteners such as trehalose, melizitose, melibiose, raffinose, palatinose, lactulose, cyclamic acid, mogroside, tagatose (e.g. D-tagatose), maltose, galactose (e.g. D-galactose), L-rhamnose, D-sorbose, maunose (e.g. Dmaunose), lactose, L-arabinose, D-ribose, D-glyceraldehyde, curculin, brazein, mogroside, neohesperidin dihydrochalcone (NHDC), neotame and other aspartame derivatives, D-tryptophan, D-leucine, D-threonine, glycine, D-asparagine, D-phenylalanine, L-proline, maltitol, hydrogenated glucose syrup (HGS), magape, sucralose, lugduname, sucononate, sucro-octate, monatin, phyllodulcin, hydrogenated starch hydrolysate (HSH), stevioside, rebaudioside A, rebaudioside D, rebadioside M and other sweet Stevia-based glycosides, lo han guo, thaumatin, monellin, carrelamine and other guanidine-based sweeteners.

According to any of the above embodiments, the composition of the invention may additionally comprise at least one cooling agent. Non-limiting examples of suitable cooling agent include WS-23 (2-Isopropyl-N,2,3-trimethylbutyramide), FEMA 3804; WS-3 (N-Ethyl-p-menthane-3-carboxamide), FEMA 3455; WS-5 [Ethyl 3-(p-menthane-3-carboxamido)acetate], FEMA 4309; WS-12 (1R,2S,5R)-N-(4-Methoxyphenyl)-p-menthanecarboxamide, FEMA 4681; WS-27 (N-Ethyl-2,2-diisopropylbutanamide), FEMA 4557; N-Cyclopropyl-5-methyl-2-isopropylcyclohexanecarboxamide, FEMA 4693, WS-116 (N-(1,1-Dimethyl-2-hydroxyethyl)-2,2-diethylbutanamide), N-(1,1-Dimethyl-2-hydroxyethyl)2,2-diethylbutanamid, FEMA 4603, Menthoxyethanol, FEMA 4154, N-(4-cyanomethylphenyl)-p-menthanecarboxamide, FEMA 4496; N-(2-(Pyridin-2-yl)ethyl)-3-p-menthanecaboxamide, FEMA 4549; N-(2-Hydroxyethyl)-2-isopropyl-2,3-dimethylbutanamide, FEMA 4602 and (also N-(4-(carbamoylmethyl)phenyl)-menthylcarboxamide, FEMA 4684; (1R,2S,5R)-N-(4-Methoxyphenyl)-pmenthanecarboxamide (WS-12), FEMA 4681; (2S,5R)-N-[4-(2-Amino-2-oxoethyl)phenyl]-pmenthanecarboxamide, FEMA 4684; and N-Cyclopropyl-5-methyl-2-isopropylcyclohexanecarbonecarboxamide, FEMA 4693; 2-[(2-p-Mentoxy)ethoxy]ethanol, FEMA 4718; (2,6-Diethyl-5-isopropyl-2-methyltetrahydropyran, FEMA 4680); trans-4-tertButylcyclohexanol, FEMA 4724; 2-(p-tolyloxy)-N-(1H-pyrazol-5-yl)-N-((thiophen-2-yl)methyl)acetamide, FEMA 4809; menthone glycerol ketal, FEMA 3807; menthone glyceryl ketal (FEMA GRAS 3808); (−)-Menthoxypropane-1,2-diol; 3-(I-Menthoxy)-2-methylpropane-1,2-diol, FEMA 3849; Isopulegol; (+)-cis & (−)-trans p-Mentane-3,8-diol, Ratio 62:38, FEMA 4053; 2,3-dihydroxy-p-mentane; trimethylcyclohexanone glycerol 3,3,5-ketal; menthyl pyrrolidone carboxylate; (1R,3R,4S)-3-menthyl-3,6-dioxaheptanoate; (1R,2S,5R)-3-menthyl methoxyacetate; (1R,2S,5R)-3-menthyl 3,6,9-trioxadecanoate; (1R,2S,5R)-3-menthyl 3,6,9-trioxadecanoate; (1R,2S,5R)-3-menthyl (2-hydroxyethoxy)acetate; (1R,2S,5R)-menthyl 11-hydroxy-3,6,9-trioxaundecanoate; Cubeball, FEMA 4497; N-(4-cyanomethylphenyl) pmentanecarboxamide, FEMA 4496; 2-isopropyl-5-methylcyclohexyl 4-(dimethylamino)-4-oxobutanoate, p-menthanecarboxamide from FEMA 4230; N-(4-cyanomethylphenyl), p-;menthanecarboxamide from FEMA 4496; N-(2-pyridin-2-ylethyl), FEMA 4549, Menthyl lactate, FEMA 3748; 6-isopropyl-3,9-dimethyl-1,4-dioxaspiro[4.5]decan-2-one, FEMA 4285; N-benzo[1,3]dioxol-5-yl-3-p-menthanecarboxamide; N-(1-isopropyl-1,2-dimethylpropyl)-1,3-benzodioxol-5-carboxamide; N—(R)-2-oxotetrahydrofuran-3-i1-(1R,2S,5R)-p-menthane-3-carboxamide; mixture of 2,2,5,6,6-pentamethyl-2,3,6,6atetrahydropentalen-3a(1H)-ol and 5-(2-hydroxy-2-methylpropyl)-3,4,4-trimethylcyclopent-2-en-1-one; (1R,2S,5R)-2-isopropyl-5-methyl-N-(2-(pyridin-2-yl)ethyl)cyclohexanecarboxamide, FEMA 4549; (2S,5R)-2-isopropyl-5-methyl-N-(2-(pyridin-4-yl)ethyl)cyclohexanecarboxamide; N-(4-cyanomethylphenyl) p-menthanecarboxamide, FEMA 4496; (1 S,2S,5R)-N-(4-(cyanomethyl)phenyl)-2-isopropyl-5-methylcyclohexanecarboxamide; 1/7-isopropyl-4/5-methyl-bicyclo[2.2.2]oct-5-ene derivatives; 4-methoxy-N-phenyl-N-[2-(pyridin-2-yl)ethyl]benzamide; 4-methoxy-N-phenyl-N-[2-(pyridin-2-yl)ethyl]benzenesulfonamide; 4-chloro-N-phenyl-N-[2-(pyridin-2-yl)ethyl]benzenesulfonamide; 4-cyano-N-phenyl-N-[2-(pyridin-2-yl)ethyl]benzenesulfonamide; 4-((benzhydrylamino)methyl)-2-methoxyphenol; 4-((bis(4-methoxyphenyl)-methylamino)-methyl)-2-methoxyphenol; 4-((1,2-diphenylethylamino)methyl)-2-methoxyphenol; 4-((benzhydryloxy)methyl)-2-methoxyphenol, 4-((9Hfluoren-9-ylamino)methyl)-2-methoxyphenol; 4-((benzhydrylamino)methyl)-2-ethoxyphenol; 1-(4-methoxyphenyl)-2-(1-methyl-1H-benzo[d]imidazol-2-yl)vinyl4-methoxybenzoate; 2-(1-isopropyl-6-methyl-1H-benzo[d]imidazol-2-yl)-1-(4-methoxyphenyl)vinyl4-methoxybenzoate; (Z)-2-(1-isopropyl-5-methyl-1H-benzo[d]imidazol-2-yl)-1-(4-methoxy-phenyl)vinyl-4-methoxybenzoate; 3-alkyl-p-methan-3-ol derivatives; fenchyl, D-bornyl, L-bornyl, exonorbornyl, 2-methylisobornyl, 2-ethylfenchyl, 2-methylbornyl, cis-pinan-2-yl, verbanyl and isobornyl derivatives; menthyl oxamate derivatives; menthyl 3-oxocarboxylic acid esters; N alpha-(Menthanecarbonyl)amino acid amides; p-menthane carboxamide and WS-23 analogues; (−)-(1R,2R,4S)-dihydroumbellulol; p-menthane alkyloxy amides; cyclohexane derivatives; butone derivatives; a mixture of 3-mentoxy-1-propanol and 1-mentoxy-2-propanol; 1-[2-hydroxyphenyl]-4-[2-nitrophenyl-]-1,2,3,6-tetrahydropyrimidine-2-one; 4-methyl-3-(1-pyrrolidinyl)-2[5H]-furanone; and combinations thereof. Preferably, the cooling agent may be selected from the group consisting of menthol, menthol methyl ether, menthone glyceryl acetal (FEMA GRAS 3807), menthone glyceryl ketal (FEMA GRAS 3808), menthyl lactate (FEMA GRAS 3748), menthyl acetate, menthol ethylene glycol carbonate (FEMA GRAS 3805), menthol propylene glycol carbonate (FEMA GRAS 3806), menthyl-N-ethyl oxamate, monomethyl succinate (FEMA GRAS 3810), monomenthyl glutamate (FEMA GRAS 4006), menthoxy-1,2-propanediol (FEMA GRAS 3784), mentoxy-2-methyl-1,2-propanediol (FEMA GRAS 3849), (1R,2S,5R)-N-(4-(cyanomethyl)phenyl)menthylcarboxamide (FEMA GRAS 4496), (1R,2S,5R)-N-(2-(pyridin-2-yl)ethyl)menthylcarboxamide (FEMA GRAS 4549), menthane carboxylic acid esters and amides WS-3, WS-4, WS-5, WS-12, WS-14, WS-30 and mixtures thereof.

According to any of the above embodiments, the aromatized composition may additionally comprise ingredient that imparts a warming, tingling, salivating, cleansing or alcohol enhancing effect, such as capsicum extract, spice extract (e.g., ginger, maniguete, all types of peppers including Sichuan, piperine, capsaicin, jambu extract, spilanto.

1-19. (canceled)

20. A perfuming, aromatizing, taste-enhancing or flavoring agent, wherein an aromatically effective amount of a mixture of extracts and fractions of extracts originating from wild, domesticated, hybridized and/or genetically modified vanilla fruits originating from a region with the biodiversity of the Brazilian Atlantic Forest or similar regions, or of adjacent biomes, with similar climate, microclimate, and/or Terroir effect similar, comprising a metabolomic profile, molecules and/or proportion of substances representative of the region's chemotype.

21. The agent, according to claim 20, wherein the mixture of extracts comprises an amount of 0.1 to 99.9% Vanilla bahiana extract, 0.1 to 99.9% Vanilla cribbiana extract, and 0.1 to 99.9% Vanilla chamissonis extract.

22. The agent, according to claim 21, wherein the mixture of extracts comprises the presence of 7-hydroxy-2-methyl-4-oxo-4H-1-benzopyran-5-acetic acid or a molecular annotation obtained through LC-ESI(−)MS/MS, negative ionization mode, [M−H]− adduct, comprising molecular fragments of m/z 147.0442; 165.0554; 205.0364 and 233.0445 with m/z 233.0432 referring to the precursor ion or similar m/z of precursor and fragment ions, considering the error of ±0.05 Da.

23. The agent, according to claim 20, wherein the mixture of extracts comprises an amount of 0.1 to 99.8% Vanilla bahiana extract, 0.1 to 99.8% Vanilla cribbiana extract, 0.1 to 99.8% Vanilla chamissonis extract, and 0.1 to 99.8% other orchid extract.

24. The agent, according to claim 22, wherein the other orchids are Vanilla planifolia.

25. The agent, according to claim 23, comprising 10-deoxygeniposidic acid or a molecular annotation obtained through LC-ESI(−)-MS/MS, negative ionization mode, adduct [M−H]−, comprising molecular fragments of m/z 67.2193; 69.4184; 70.8549; 78.9176; 80.9154; 93.0340; 139.4668; 149.0599; 198.9329; 309.6381; 311.1108; 356.8289; and 357.1172, having m/z 357.1197 referring to the precursor ion or similar m/z of precursor ions and fragments, considering the error of +0.05 Da, either glycovanillin or a molecular annotation obtained through LC-ESI(−)-MS/MS, negative ionization mode, [M−H]− adduct, comprising the molecular fragments of m/z 151.0384 and 136.0161, with m/z 313.0935 referring to the precursor ion, or similar m/z of precursor and fragment ions, considering the error of +0.05 Da.

26. The agent, according to claim 20, wherein the mixture of extracts comprising an amount of 0.1 to 99.8% of Vanilla cribbiana extract, 0.1 to 99.8% of Vanilla chamissonis extract, and 0.1 to 99.8% of extract from other orchids from the same region, adjacent or similar regions.

27. The agent, according to claim 20, wherein the mixture of extracts comprising an amount of 0.1 to 99.7% Vanilla bahiana extract, 0.1 to 99.7% Vanilla chamissonis extract, of 0.1 to 99.7% of Vanilla cribbiana extract, and 0.1 to 99.7% of the extract of other orchids from the same region, adjacent or similar regions and 0.1 to 99.7% of the extract of commercial orchids.

28. The agent, according to all claim 20, wherein a metabolomic profile that presents the following compounds as the most frequent components: vanillin, vanillic alcohol (or vanillyl alcohol), vanillic acid, p-hydroxybenzyl alcohol, p-hydroxybenzaldehyde, p-hydroxybenzoic acid, anisyl alcohol, anisaldehyde, acetovanillone, and anisic acid or molecular annotations obtained through LC-ESI-MS/MS, in negative or positive ionization modes, comprising all or part of the m/z values of precursor ions and molecular fragments, considering the error of +0.05 Da being in negative ionization mode and adduct [M−H]−: m/z of precursor ion 151.0391 corresponding to vanillin with m/z of fragment ions 151.0384; 136.0161; m/z of precursor ion 153.0549 corresponding to vanillic alcohol with m/z of fragment ions 153.0546; 139.0382; 137.0236 123.0443; 121.0282; m/z of precursor ion 167.0341 corresponding to vanillic acid with m/z of fragment ions 167.0338; 149.0238; 123.0442; 121.0282; 93.0332; m/z of precursor ion 137.0235 corresponding to p-hydroxybenzoic acid with m/z of fragment ions 137.0236; 136.0161; and being in positive ionization mode and [M+H]+ adduct: m/z of the precursor ion 153.0546 corresponding to vanillin with m/z of fragment ions 153.0547; 125.0600; 111.0436; 93.0339; 65.0393; m/z of precursor ion 167.0703 corresponding to acetovanillone with m/z of fragment ions 167.0699; 125.0595; 111.0440; 110.0363.

29. The agent, according to all claim 20, wherein enriching its composition with the following compounds alone or together: vanillin, vanillic alcohol (or vanillyl alcohol), vanillic acid, p-hydroxybenzyl alcohol, p-hydroxybenzaldehyde, p-hydroxybenzoic acid, anisyl alcohol, anisaldehyde, ethyl vanillin, and/or anisic acid or molecular annotations obtained through LC-ESI-MS/MS, in negative or positive ionization modes, comprising all or part of the m/z values of precursor ions and molecular fragments, considering the error of +0.05 Da being in negative ionization mode and adduct [M−H]−: m/z of precursor ion 151.0391 corresponding to vanillin with m/z of fragment ions 151.0384; 136.0161; m/z of precursor ion 153.0549 corresponding to vanillic alcohol with m/z of fragment ions 153.0546; 139.0382; 137.0236; 123.0443; 121.0282; m/z of precursor ion 167.0341 corresponding to vanillic acid with m/z of fragment ions 167.0338; 149.0238; 123.0442; 121.0282; 93.0332; m/z of precursor ion 137.0235 corresponding to p-hydroxybenzoic acid with m/z of fragment ions 137.0236; 136.0161; and being in positive ionization mode and [M+H]+ adduct: m/z of the precursor ion 153.0546 corresponding to vanillin with m/z of fragment ions 153.0547; 125.0600; 111.0436; 93.0339; 65.0393; m/z of precursor ion 167.0703 corresponding to acetovanilone with m/z of fragment ions 167.0699; 125.0595; 111.0440; 110.0363.

30. The agent, according to all claim 20, wherein the complex mixtures are selected from two or more extracts and fractions that have a metabolomic profile characteristic of Vanilla bahiana, Vanilla chamissonis, or Vanilla cribbiana presenting as components the following annotations molecular measurements, obtained through LC-ESI-MS/MS, in negative or positive ionization modes, being related to several metabolites with potential flavor of these species, comprising all or part of the m/z values of precursor ions and molecular fragments, considering the error of +0.05 Da being in the negative ionization mode and adduct [M−H]−: m/z of precursor ion 289.0722, with m/z of fragment ions 289.0727; 259.0602; 137.0236; 136.0161; m/z of precursor ion 281.2491, with m/z of fragment ions 281.2505; 213.0154; 1449232; m/z of precursor ion 167.0341, with m/z of fragment ions 167.0338; 149.0238; 123.0442; 121.0282; 93.0332; m/z of precursor ion 253.0928, with m/z of fragment ions 253.0936; 161.0441; 119.0341; 113.0237; 101.0230; 89.0225; 71.0124; 59.0125; m/z of precursor ion 461.1032, with m/z of fragment ions 461.1078; 415.0974; 371.1084; 367.0737; 294.0342; m/z of precursor ion 121.0295, with m/z of fragment ions 121.0309; 108.0229; 93.0353; m/z of precursor ion 137.0244, with m/z of fragment ions 138.0286; 137.0252; 136.0174; m/z of precursor ion 163.0400, with m/z of fragment ions 162.8408; 123.9477; 118.9942; 103.9213; m/z of precursor ion 165.0548, with m/z of fragment ions 165.0554; 147.0442; 135.0436; m/z of precursor ion 175.0602, with m/z of fragment ions 175.0610; 157.0496; 146.9597; 115.0386; 85.0644; m/z of precursor ion 259.0981, with m/z of fragment ions 259.0966; 181.0489; 137.0602; 121.0283; m/z of precursor ion 325.0927, with m/z of fragment ions 325.0957; 265.0717; 187.0240; 143.0343; 125.0237; 99.0436; m/z of precursor ion 343.083, with m/z of fragment ions 179.0353; 177.0192; 165.0555; 135.0437; 133.0290; m/z of precursor ion 345.1352, with m/z of fragment ions 345.1325; 299.1294; 283.0980; 251.1068; m/z of precursor ion 357.1197, with m/z of fragment ions 357.1172; 311.1108; 149.0599; m/z of precursor ion 469.136, with m/z of fragment ions 299.1148; 125.0236; m/z of precursor ion 507.1724, with m/z of fragment ions 461.1653; 299.1146; 161.0440; m/z of precursor ion 547.1685, with m/z of fragment ions 503.1761; 461.1653; 299.1141; 161.0437; 101.0228; 71.0125; 59.0126; or being, in the positive ionization mode and [M+NH4]+ adduct: m/z of the precursor ion 318.154, with m/z of fragment ions 318.1582; 180.0857; 121.0652; m/z of precursor ion 404.1546, with m/z of fragment ions 217.0156; 121.0654; m/z of precursor ion 430.1707, with m/z of fragment ions 385.1282; 121.0652; 113.0592; 78.0467; or being, in the positive ionization mode and [M+Na]+ adduct: m/z of the precursor ion 323.11, with m/z of fragment ions 323.1075; 121.0561; or being, in the positive ionization mode and [M+H−H2O]+ adduct: m/z of the precursor ion 121.0648, with m/z of fragment ions 106.0411; 91.0541; or being, in the positive ionization mode and [M+H]+ adduct: m/z of the precursor ion 121.0649, with m/z of fragment ions 91.0541; 78.0468; m/z of precursor ion 133.0649, with m/z of fragment ions 105.0702; 103.0548; m/z of precursor ion 151.0752, with m/z of fragment ions 135.0443; 118.0344; 107.0497; m/z of precursor ion 153.0546, with m/z of fragment ions 153.0555; 125.0605; 111.0449; 93.0344; 65.0396; m/z of precursor ion 167.0714, with m/z of fragment ions 167.0717; 144.9664; 120.9814; 102.9714; m/z of precursor ion 169.0495, with m/z of fragment ions 169.0507; 151.0402; 146.9625; 128.9518; 125.0608; 111.0452; m/z of precursor ion 175.1188, with m/z of fragment ions 158.0924; 130.0974; 116.0708; 112.0760; 70.0656; 60.0563; m/z of precursor ion 337.1072, with m/z of fragment ions 337.1073; 243.0639; 201.0534 147.0438; 141.0175; 133.0646; or being, in the positive ionization mode and adduct [M+CH₃OH+H]+: m/z of the precursor ion 156.0764, with m/z of fragment ions 110.0711; 93.0447; 83.0606.

31. A perfuming, aromatizing, taste-enhancing or flavoring agent, wherein it comprises the main element(s) of Vanilla bahiana extract, Vanilla chamissonis extract, Vanilla cribbiana extract, and/or flavoring agents as defined in claim 20, isolated or together added to an effective amount of one or more co-ingredients, vanilla enhancers, liquid or solid aroma or perfume carriers, perfume solvents, flavor adjuvant, perfume adjuvant, sweetener and/or an effective amount of elements that function such as: vehicles, additives, thickeners, preservatives, foaming agents or defoamers acceptable in human consumption, pharmaceutically or cosmetically acceptable.

32. The composition, according to claim 30, wherein its main element is the extract or extract fractions of pure V. bahiana.

33. The composition, according to claim 30, wherein its main element is the extract or extract fraction of pure V. chamissonis.

34. The composition, according to claim 30, wherein its main element is the extract or extract fraction of pure V. cribbiana.

35. The composition, according to claim 30, wherein the main element is any of the agents defined in claim 20.

36. A production process of the perfuming, aromatizing, taste-enhancing or flavoring agent or composition wherein the following steps are followed:
a. pollinating flowers;
b. collecting fruits (or capsules, pods, pods, beans, vanilla beans), isolated or together;
c. curing or not of the fruits, processing or not of the fruits, grinding, slicing, crushing or not of the fruits;
d. preparing extracts with solvents (methanol, ethanol, water, glycerin, isopropanol, among others) by infusion and/or maceration and/or percolation and/or distillation and/or decoction and/or digestion and/or by supercritical fluid and/or by countercurrent and/or assisted by microwaves and/or assisted by ultrasonication or other techniques, which may be cold or hot;
e. filtering the extracts or not (separation of residues from the liquid) or clarifying by subsidence or not;
f. optional obtaining of dry extracts in powder form, mixed with sugar, and/or starch or other substances;
g. optionally obtaining liquid extracts with low or high viscosity, such as extracts in alcohol (ethanol), in isopropanol and/or glycerin and/or sugar and/or thickeners and/or corn syrup and/or dextrose and/or propylene glycol and/or other solvents comprising or not water;
h. optionally obtaining vanilla essence, being a more concentrated extract by vacuum distillation or other extract volume reduction techniques.

37. The use of perfuming, aromatizing, taste-enhancing or flavoring agent, wherein the agents as defined in claim 20 or the compositions as defined in claims 30 to 34 are used for the manufacture of flavoring, aromatizing products with biological and physical-chemical properties of interest for the manufacture of products, cosmetic, pharmaceutical, food, aromatic, cosmeceutical, dermocosmetic, nutraceutical compositions and formulations, textile, wooden, plastic articles, among other uses of orchid-based flavoring agents, additives, adjuvants, vehicles, thickeners, preservatives, foaming agents or defoamers acceptable in food, pharmaceutical, cosmetic and perfume industries.

38. The use, according to claim 36, wherein the manufactured products, compositions and formulations are compounds, extracts and fractions of medicinal plants, bioactive compounds, pharmaceutically acceptable adjuvants, pharmaceutically active ingredients, sweeteners, preservatives, conservants, essences, perfumes, antioxidant, anti-inflammatory, anti-diabetic, anti-cancer products, among other medicinal uses.

39. The use, according to claim 37, wherein the manufactured products, compositions and formulations are aimed at flavoring agents, natural vanilla flavoring agents, vanilla concentrate, Vanilla concrete vanilla pomace, vanilla syrup, vanilla paste, vanilla oleoresin, Vanilla Absolute, vanilla-vanillin extract, vanilla powder and/or vanilla pomace powder.
